(19) United States
(12) Patent Application Publication
(10) Pub. No.: US 2004/0247175 A1
(43) Pub. Date: Dec. 9, 2004

(54) Image processing method, image capturing apparatus, image processing apparatus and image recording apparatus

(75) Inventors: Hiroaki Takano, Tokyo (JP); Takeshi Nakajima, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Photo Imaging, Inc., Tokyo (JP)

(21) Appl. No.: 10/854,135

(22) Filed: May 26, 2004

(30) Foreign Application Priority Data
Jun. 3, 2003 (JP) JP2003-157703

(51) Int. Cl. G06K 9/00

(52) U.S. Cl. 382/154

(57) ABSTRACT

There is described an image processing method for providing a highly versatile and convenient way of recording the captured-image data for stereoscopic vision display and an image-capturing apparatus, image processing apparatus and image recording apparatus based on this method. The image-processing method is applied. The image-processing method, for outputting one of a plurality of captured image data sets, each of which represents each of a plurality of images acquired by photographing a same subject from plural viewpoints being different relative to each other, includes the steps of: selecting a reference image data set out of the plurality of captured image data sets; extracting differential image data between the reference image data set and other captured image data sets; and attaching the differential image data, extracted in the extracting step, and attachment-identifying information of the differential image data to the reference image data set.

### BACKGROUND OF THE INVENTION

The present invention relates to an image processing method for captured image data used for stereoscopic vision display, an image-capturing apparatus according to this image processing method, an image processing apparatus and an image recording apparatus.

A stereoscopic vision display for providing three-dimensional image (stereoscopic image) based on an image arranged on a plane is known in the prior art. Stereoscopic vision display can be provided by various means, all of which requires two images for producing a parallax.

Two images for stereoscopic vision display are acquired by photographing one and the same subject from different viewpoints. To get natural spatial perception, the distance between viewpoints, i.e. distance between lenses, is about 6 through 7 cm, which is equal to the distance between human eyes.

In the stereoscopic vision display called a stereopair, two images causing the above-mentioned parallax are arranged on a plane, with each image size adjusted in such a way that these two images will be kept at a distance of at least about 6 through 7 cm, equal to the distance between human eyes.

The images in stereoscopic vision display arranged on the plane can be observed in two ways; a parallel method of using the right eye to view one of the images placed on the right, and a cross method of using the left eye to view one of the images placed on the right. The parallel method allows easy viewing without extra effort required, but does not permit a larger image to be viewed, on the one hand. On the other hand, the cross method allows a larger image to be viewed, although images must be viewed with eyes crossed, and your eyes will get tired sooner.

With the widespread use of a digital camera in recent years, there have been an increasing number of instances of enjoying a stereoscopic vision display wherein a digital camera is used to shoot the images used for it. In the general digital camera having only one image-capturing optical system, for example, a digital camera with an auxiliary function is proposed, wherein two continuous shots are taken of one and the same subject, and the position of the photographer is shifted to the side before the second shot, thereby getting captured-image data for stereoscopic vision-display.

To record the images for stereoscopic vision display, the art of utilizing the difference between two images is proposed, as disclosed in Patent Documents 1 through 3, for example.

A great number of image processing methods based on stereoscopic vision display and the new examples of use have been proposed, as exemplified in the use of the captured-image data for stereoscopic vision display to acquire the altitude measurement data for creating a stereoscopic map and the diagnosis data (e.g. an x-ray radiograph) for medical treatment, or to select the samples of insects.

On the other hand, the digital image data captured by an image-capturing apparatus, such as a digital camera, etc., is distributed through such a memory device as a CD-R (Compact Disk Recordable), floppy disk (registered trade name) and memory card or the Internet, and is displayed on such a display monitor as a CRT (Cathode Ray Tube), liquid crystal display and plasma display or a small-sized liquid crystal monitor display device of a cellular phone, or is printed out as a hard copy image using such an output device as a digital printer, inkjet printer and thermal printer. In this way, display and print methods have been diversified in recent years.

When captured image data is displayed or printed out for viewing, it is a common practice to provide various types of image processing typically represented by gradation adjustment, brightness adjustment, color balancing and enhancement of sharpness to ensure that a desired image quality is obtained on the display monitor used for viewing or on the hard copy.

In response to such varied display and printing methods, efforts have been made to improve the general versatility of captured image data captured by an image-capturing apparatus. As part of these efforts, an attempt has been made to standardize the color space represented by digital RGB (Red, Green and Blue) signals into the color space that does not depend on characteristics of an image-capturing apparatus. At present, large amounts of digital image data have adopted the sRGB (See Multimedia Systems and Equipment—Color Measurement and Management—Part 2-1: Color Management—Default RGB Color Space—sRGB” IEC61966-2-1) as a standardized color space. The color space of this sRGB has been established to meet the color reproduction area for a standard CRT display monitor.

A digital camera of general use is equipped with an image sensor, serving as an image-capturing device (CCD type image sensor, hereinafter also referred to as “CCD” for simplicity) having a photoelectric conversion function with color sensitivity provided by a combination of a CCD (charge coupled device), a charge transfer device and a mosaic color filter.

The captured image data outputted from the digital camera is obtained after the electric original signal gained by conversion via the CCD has been corrected by the photoelectric conversion function of the image sensor, (for instance, an image-processing operation, such as gradation correction, crosstalk correction of spectral sensitivity, suppression of dark current noise, sharpening, white balance adjustment and color saturation adjustment) and processing of file conversion and compression into the predetermined data format standardized to permit reading and display by image editing software.

The above-mentioned data format widely known includes Baseline Tiff Rev. 6.0 RGB Full Color Image adopted as a non-compressed file of the Exif (Exchangeable Image File Format) file and compressed data file format conforming to the JPEG format.

The Exif file conforms to the above-mentioned sRGB, and the correction of the photoelectric conversion function of the above-mentioned image-capturing element is established so as to ensure the most suitable image quality on the display monitor conforming to the sRGB.

For example, if a digital camera has the function of writing into the header of the captured image data the tag information for display in the standard color space (hereinafter referred to as “monitor profile”) of the display monitor conforming to the sRGB signal, and accompanying information indicating the device dependent information such as the number of pixels, pixel arrangement and number of bits per pixel as meta-data, and if only such a data format is adopted, then the tag information can be analyzed by the image edit software (e.g. Photoshop by Abode for displaying the above-mentioned digital image data on the digital display monitor, conversion of the monitor profile into the sRGB can be prompted, and modification can be processed automatically. This capability reduces the differences in apparatus characteristics among different displays, and permits viewing of the captured image data photographed by a digital camera under the optimum condition.

In addition to the above-mentioned information dependent on device type, the above-mentioned accompanying information includes; information directly related to the camera type (device type) such as a camera name and code number, information on photographing conditions such as exposure time, shutter speed, f-stop number (F number), ISO sensitivity, brightness value, subject distance range, light source, on/off status of a stroboscopic lamp, subject area, white balance, zoom scaling factor, subject configuration, photographing scene type, the amount of reflected light of the stroboscopic lamp source and color saturation for photographing, and tags (codes) for indicating the information related to a subject. The image editing software and output device have a function of reading the above-mentioned accompanying information and making the quality of hardware image more suitable.

[Patent Document 1]

JP-A 10-28274

[Patent Document 2]

JP-A 6-30445

[Patent Document 2]

JP-A 7-30924

In contrast with widespread use of stereoscopic vision display and a growing number of opportunities to utilize it as described above, sufficient efforts have not yet been made to improve versatility and convenience of the captured-image data obtained for stereoscopic vision display.

For example, the prior art fails to achieve automatic retrieval of captured-image data sets for stereoscopic vision display from a plurality of captured-image data sets, or to enable simultaneous processing of photographic prints for normal use and those for stereoscopic vision display in a series of steps for producing photographic prints.

Further, an output device incapable of creating a hard copy of images for stereoscopic vision display fails to permit effective creation of a normal hard copy by using one of the images alone.

### SUMMARY OF THE INVENTION

To overcome the abovementioned drawbacks in conventional methods and apparatus, it is an object of the present invention to provide an image processing method for providing a highly versatile and convenient way of recording the captured-image data for stereoscopic vision display, and an image-capturing apparatus, image processing apparatus and image recording apparatus based on this method.

Accordingly, to overcome the cited shortcomings, the abovementioned object of the present invention can be attained by image-processing methods and apparatus, image-capturing apparatus and image-recording apparatus described as follow.

(1) An image-processing method for outputting one of a plurality of captured image data sets, each of which represents each of a plurality of images acquired by photographing a same subject from plural viewpoints being different relative to each other, the image-processing method comprising the steps of: selecting a reference image data set out of the plurality of captured image data sets; extracting differential image data between the reference image data set selected in the selecting step and other captured image data sets, both included in the plurality of captured image data sets; and attaching the differential image data, extracted in the extracting step, and attachment-identifying information of the differential image data to the reference image data set.

(2) The image-processing method of item 1, wherein the attachment-identifying information are recorded into a header area of the reference image data set as tag information in the attaching step.

(3) The image-processing method of item 1, wherein the captured image data sets are scene-referred image data sets.

(4) An image-processing method for generating output image data by applying an optimization processing, for optimizing an output image to be formed on an outputting medium, to captured image data, the image-processing method comprising the steps of: inputting a reference image data set to which differential image data and attachment-identifying information of the differential image data are attached; separating the differential image data from the reference image data set, based on the attachment-identifying information; generating parallax image data, based on both the reference image data set and the differential image data, both separated in the separating step; and generating stereoscopic-vision image data for forming a stereoscopic vision on the outputting medium, based on the reference image data set and the parallax image data; wherein the reference image data set is selected out of a plurality of captured image data sets, each of which represents each of a plurality of images acquired by photographing a same subject from plural viewpoints being different relative to each other, and the differential image data represent differential components between the reference image data set and other captured image data sets, both included in the plurality of captured image data sets.

(5) The image-processing method of item 4, wherein the attachment-identifying information are tag information recorded into a header area of the reference image data set.

(6) The image-processing method of item 4, wherein the captured image data sets are scene-referred image data sets; and further comprising the steps of: applying the optimization processing, for optimizing the output image to be formed on the outputting medium, to the reference image data set and the parallax image data, so that the scene-referred image data sets are converted to output-referred image data.

(7) An image-capturing apparatus for generating a plurality of captured image data sets, each of which represents each of a plurality of images acquired by photographing a same subject from plural viewpoints being different relative to each other, the image-capturing apparatus comprising: a reference image data selecting section to select a reference image data set out of the plurality of captured image data sets; a differential image data extracting section to extract differential image data between the reference image data set selected by the reference image data selecting section and other captured image data sets, both included in the plurality of captured image data sets; and a data attaching section to attach the differential image data, extracted by the differential image data extracting section, and attachment-identifying information of the differential image data to the reference image data set.

(8) The image-capturing apparatus of item 7, wherein the data attaching section records the attachment-identifying information into a header area of the reference image data set as tag information.

(9) The image-capturing apparatus of item 7, wherein the captured image data sets are scene-referred image data sets.

(10) An image-processing apparatus for outputting one of a plurality of captured image data sets, each of which represents each of a plurality of images acquired by photographing a same subject from plural viewpoints being different relative to each other, the image-processing apparatus comprising: a reference image data selecting section to select a reference image data set out of the plurality of captured image data sets; a differential image data extracting section to extract differential image data between the reference image data set selected by the reference image data selecting section and other captured image data sets, both included in the plurality of captured image data sets; and a data attaching section to attach the differential image data, extracted by the differential image data extracting section, and attachment-identifying information of the differential image data to the reference image data set.

(11) The image-processing apparatus of item 10, wherein the data attaching section records the attachment-identifying information into a header area of the reference image data set as tag information.

(12) The image-processing apparatus of item 10, wherein the captured image data sets are scene-referred image data sets.

(13) An image-processing apparatus for generating output image data by applying an optimization processing, for optimizing an output image to be formed on an outputting medium, to captured image data, the image-processing apparatus comprising: an inputting section to input a reference image data set to which differential image data and attachment-identifying information of the differential image data are attached; an identifying section to identify the attachment-identifying information so as to output an identified result; a data separating section to separate the differential image data from the reference image data set, based on the identified result outputted by the data separating section; a parallax image data generating section to generate parallax image data, based on both the reference image data set and the differential image data, both separated by the data separating section; and a stereoscopic-vision image data generating section to generate stereoscopic-vision image data for forming a stereoscopic vision on the outputting medium, based on the reference image data set and the parallax image data; wherein the reference image data set is selected out of a plurality of captured image data sets, each of which represents each of a plurality of images acquired by photographing a same subject from plural viewpoints being different relative to each other, and the differential image data represent differential components between the reference image data set and other captured image data sets, both included in the plurality of captured image data sets.

(14) The image-processing apparatus of item 13, wherein the attachment-identifying information are tag information recorded into a header area of the reference image data set.

(15) The image-processing apparatus of item 13, wherein the captured image data sets are scene-referred image data sets; and the image-processing apparatus further comprising: an output-referred image data generating section to convert the scene-referred image data sets to output-referred image data by applying the optimization processing, for optimizing the output image to be formed on the outputting medium, to the reference image data set and the parallax image data; wherein the stereoscopic-vision image data generating section generates the stereoscopic-vision image data, based on the output-referred image data.

(16) An image-recording apparatus that forms an output image on an outputting medium, based on output image data generated by applying an optimization processing to captured image data, the image-recording apparatus comprising: an inputting section to input a reference image data set to which differential image data and attachment-identifying information of the differential image data are attached; an identifying section to identify the attachment-identifying information so as to output an identified result; a data separating section to separate the differential image data from the reference image data set, based on the identified result outputted by the data separating section; a parallax image data generating section to generate parallax image data, based on both the reference image data set and the differential image data, both separated by the data separating section; a stereoscopic-vision image data generating section to generate stereoscopic-vision image data for forming a stereoscopic vision on the outputting medium, based on the reference image data set and the parallax image data; and an image-forming section to form a stereoscopic-vision image onto the outputting medium, based on the stereoscopic-vision image data generated by the stereoscopic-vision image data generating section; wherein the reference image data set is selected out of a plurality of captured image data sets, each of which represents each of a plurality of images acquired by photographing a same subject from plural viewpoints being different relative to each other, and the differential image data represent differential components between the reference image data set and other captured image data sets, both included in the plurality of captured image data sets.

(17) The image-recording apparatus of item 16, wherein the attachment-identifying information are tag information recorded into a header area of the reference image data set.

(18) The image-recording apparatus of item 17, wherein the captured image data sets are scene-referred image data sets; and further comprising: an output-referred image data generating section to convert the scene-referred image data sets to output-referred image data by applying the optimization processing, for optimizing the output image to be formed on the outputting medium, to the reference image data set and the parallax image data; and wherein the stereoscopic-vision image data generating section generates the stereoscopic-vision image data, based on the output-referred image data.

Further, to overcome the abovementioned problems, other image-processing methods and apparatus, image-capturing apparatus, image-processing apparatus and image-recording apparatus, embodied in the present invention, will be described as follow:

(19) An image-processing method, characterized in that, in the image-processing method for outputting a captured image data set from a plurality of captured image data sets, which are acquired by photographing a same subject from different viewpoints, there are included:

a selecting process for selecting a reference image data set out of the plurality of captured image data sets;

an extracting process for extracting differential image data between the reference image data set selected in the selecting process and other captured image data sets;

an attaching process for attaching the differential image data, extracted in the extracting process, to the reference image data set; and

an attaching process for attaching attachment-identifying information, which indicates that the differential image data are attached, to the reference image data set.

(20) The image-processing method, described in item 19, characterized in that,

by recording the attachment-identifying information into a header area of the reference image data set as tag information, there is included the attaching process for attaching to the reference image data set.

(21) The image-processing method, described in item 19 or 20, characterized in that

the captured image data sets are scene-referred image data sets.

(22) An image-processing method, characterized in that, in the image-processing method for processing input-captured image data so as to output image data optimized for viewing on an outputting medium, there are included:

an inputting process for inputting differential image data including differential contents between a reference image data set selected out of a plurality of captured image data sets acquired by photographing a same subject from different viewpoints and other captured image data sets, the reference image data set to which the differential image data are attached, and the attachment-identifying information, which indicates that the differential image data are attached to the reference image data set;

a separating process for separating the reference image data and the differential image data from each other;

a generating process for generating parallax image data, based on both the reference image data and the differential image data, both separated in the separating process; and

a generating process for generating stereoscopic-vision image data, based on the reference image data set and the parallax image data.

(23) The image-processing method, described in item 22, characterized in that

the attachment-identifying information are tag information recorded into a header area of the reference image data set inputted in inputting process.

(24) The image-processing method, described in item 22 or 23, characterized in that

the input-captured image data sets are scene-referred image data sets, and there is included:

a converting process for converting to output-referred image data by applying an optimization processing to the reference image data set and the parallax image data.

(25) An image-capturing apparatus, characterized in that, in the image-capturing apparatus for acquiring a plurality of captured image data sets by photographing a same subject from different viewpoints, there are provided:

an image data selecting means for selecting at least a reference image data set out of the plurality of captured image data sets;

a differential image data generating means for extracting differential image data including differential contents between the reference image data set selected and other captured image data sets; and

an attachment processing means for attaching the extracted differential image data, and further, attachment-identifying information, which indicates that the differential image data are attached, to the reference image data set.

(26) The image-capturing apparatus, described in item 25, characterized in that

the attachment processing means attaches the attachment-identifying information to the reference image data set by recording the attachment-identifying information into a header area of the reference image data set as tag information.

(27) The image-capturing apparatus, described in item 25 or 26, characterized in that

the captured image data sets are scene-referred image data sets.

(28) An image-processing apparatus, characterized in that,

in the image-processing apparatus, which outputs a captured image data set out of a plurality of captured image data sets acquired by photographing a same subject from different viewpoints, there are provided:

an reference image data selecting means for selecting at least a reference image data set out of the plurality of captured image data sets;

a differential image data extracting means for extracting differential image data including differential contents between the reference image data set and other captured image data sets;

a differential image data attaching means for attaching the extracted differential image data to the reference image data set; and

an information attaching means for attaching attachment-identifying information, which indicates that the differential image data are attached, to the reference image data set.

(29) The image-processing apparatus, described in item 28, characterized in that

the attachment processing means attaches the attachment-identifying information to the reference image data set by recording the attachment-identifying information into a header area of the reference image data set as tag information.

(30) The image-processing apparatus, described in item 28 or 29, characterized in that

the captured image data sets are scene-referred image data sets.

(31) An image-processing apparatus, characterized in that,

in the image-processing apparatus for processing input-captured image data so as to output image data optimized for viewing on an outputting medium, there are provided:

an inputting means for inputting differential image data including differential contents between a reference image data set selected out of a plurality of captured image data sets acquired by photographing a same subject from different viewpoints and other captured image data sets, the reference image data set to which the differential image data are attached, and the attachment-identifying information, which indicates that the differential image data are attached to the reference image data set;

an judging means for judging the attachment-identifying information;

a data separating means for separating the reference image data and the differential image data from each other, based on the judging result;

a parallax image data generating means for generating parallax image data, based on both the reference image data and the differential image data, both separated; and

a stereoscopic-vision image data generating means for generating stereoscopic-vision image data, based on the reference image data set and the parallax image data.

(32) The image-processing apparatus, described in item 31, characterized in that

the attachment-identifying information are tag information recorded into a header area of the reference image data set inputted in inputting process.

(33) The image-processing apparatus, described in item 31 or 32, characterized in that

the input-captured image data sets are scene-referred image data sets, and there is provided:

an output-referred image data generating means for converting to output-referred image data by applying an optimization processing to the reference image data set and the parallax image data; and

wherein the stereoscopic-vision image data generating means generates the stereoscopic-vision image data, based on the reference image data set and the parallax image data converted to the output-referred image data.

(34) An image-recording apparatus, characterized in that,

in the image-recording apparatus for processing input-captured image data so as to generate image data optimized for viewing on an outputting medium and for forming a visual image on the outputting medium, there are provided:

an inputting means for inputting differential image data including differential contents between a reference image data set selected out of a plurality of captured image data sets acquired by photographing a same subject from different viewpoints and other captured image data sets, the reference image data set to which the differential image data are attached, and the attachment-identifying information, which indicates that the differential image data are attached to the reference image data set;

an judging means for judging the attachment-identifying information;

a data separating means for separating the reference image data and the differential image data from each other, based on the judging result;

a parallax image data generating means for generating parallax image data, based on both the reference image data and the differential image data, both separated;

a stereoscopic-vision image data generating means for generating stereoscopic-vision image data, based on the reference image data set and the parallax image data; and

an image-forming means for forming the visual image of stereoscopic-vision use, based on the stereoscopic-vision image data generated in the above.

(35) The image-recording apparatus, described in item 38, characterized in that

the attachment-identifying information are tag information recorded into a header area of the reference image data set inputted in inputting process.

(36) The image-recording apparatus, described in item 34 or 35, characterized in that

the input-captured image data sets are scene-referred image data sets, and there is provided:

an output-referred image data generating means for converting to output-referred image data by applying an optimization processing to the reference image data set and the parallax image data; and

wherein the stereoscopic-vision image data generating means generates the stereoscopic-vision image data, based on the reference image data set and the parallax image data converted to the output-referred image data.

At least one reference image data set is selected from a plurality of captured-image data sets acquired by photographing one and the same subject from different viewpoints, and a differential image data set between the selected reference image data and other captured-image data is extracted. The extracted differential image data is attached to the reference image data, and the attachment identifying information for indicating attachment of that differential image data is attached to the reference image data.

Thus, a plurality of captured-image data sets acquired by photographing one and the same subject from different viewpoints, i.e. a plurality of captured-image data sets acquired by photographing for the purpose of stereoscopic vision display, can be handled as a single captured-image data set. This arrangement improves the searching efficiency in searching the captured-image data acquired by photographing for the purpose of stereoscopic vision display from a plurality of captured-image data sets, and permits outputting as one photographic print of the reference image data by the printer incompatible with stereoscopic vision display. This improves compatibility between the captured-image data acquired by photographing for the purpose of stereoscopic vision display and the normal captured-image data acquired by photographing one and the same subject from different viewpoints, and upgrades the versatility and convenience of the captured-image data for stereoscopic vision display.

It is preferred that attachment identifying information be recorded on the header area of the captured-image data as tag information. Further, to ensure that the captured-image data can be processed into the optimum image data in conformity to a destination, it is preferred that the data be outputted as scene-referred image data without information loss from the information obtained by photographing.

Upon entry of the differential image data containing the difference between the reference image data out of a plurality of captured-image data sets acquired by photographing one and the same subject from different viewpoints and other captured-image data, the reference image data with this differential image data attached thereto, and the attachment identifying information for indicating attachment of the differential image data to the reference image data, the reference image data is separated from the differential image data based on the attachment identifying information. Based on the separated reference image data and differential image data, the parallax image data is generated, and based on the reference image data and parallax image data, image data for stereoscopic vision display is generated. Further, the image recording apparatus allows the image data for stereoscopic vision display to be formed on an output medium.

Thus, automatic identification is performed to confirm that the inputted captured-image data is the reference image data, acquired by photographing for the purpose of stereoscopic vision display, with the differential image data attached thereto, i.e. the data of the format generated by the image processing method, image-capturing apparatus and image processing apparatus embodied in the present invention. This arrangement makes it possible to generate image data for stereoscopic vision display from the reference image data and differential image data, and enables effective generation of image data for stereoscopic vision display.

It is preferred that the attachment identifying information be recorded on the header area of captured-image data as tag information. It is also preferred that the inputted data be scene-referred image data without information loss from the information obtained by photographing. The optimization processing for forming the optimum image on the output medium is applied to the reference image data of the scene-referred image data and the parallax image data, and the data is converted into the scene-referred image data, whereby the optimum image of the still higher degree can be obtained on the output medium.

The following defines the terms used in the present invention:

“A plurality of captured-image data sets acquired by photographing one and the same subject from different viewpoints” refers to at least two captured-image data sets, photographed by an image-capturing apparatus, required for stereoscopic vision display by a stereopair. In the description of the present specification it is synonymous with “a plurality of captured-image data sets for stereoscopic vision display”.

The following three methods can be used to get a plurality of captured-image data sets for stereoscopic vision display:

1. By at least two shots by changing the position of one image-capturing apparatus

2. By one shot using two image-capturing apparatuses arranged at a specified interval

3. By one image-capturing apparatus having two image-capturing optical systems arranged at a specified interval

It is preferred that one image-capturing apparatus having two image-capturing optical systems of the above-mentioned item (3) is used to acquire a plurality of captured-image data sets used in the image processing method embodied in the present invention, and the same image-capturing apparatus be used as the image-capturing apparatus embodied in the present invention.

“Captured-image data” is preferred to be scene-referred image data. The term of “scene-referred image data” will be detailed in the following.

The term “scene-referred image data” used in the specification of the present application refers to the image data obtained by applying processing of mapping the signal intensity of each color channel based on at least the spectral sensitivity of the image sensor itself to the standard color space such as the aforementioned, sRGB (relative scene RGB color space), RIMM RGB (Reference Input Medium Metric RGB) and ERIMM RGB (Extended Reference Input Medium Metric RGB). The term signifies the image data where image processing of modifying the data contents as to improve the effect of viewing the image such as gradation conversion, sharpness enhancement and color saturation enhancement is omitted. It is preferred that the scene-referred raw data be subjected to correction (opto-electronic conversion function defined in ISO1452, e.g. “Fine imaging and digital photographing” edited by the Publishing Commission of the Japan Society of Electrophotography, Corona Publishing Co., P. 449) of the photoelectric conversion characteristics of the image-capturing apparatus.

It is preferred that the amount of the scene-referred image data (e.g. number of gradations) be equal to or greater than the amount of information (e.g. the number of gradations) required by the output-referred image data (to be described later) according to the performance of the aforementioned analog-to-digital converter. For example, when the number of gradations of the output-referred image data is 8 bits per channel, the number of gradations of the scene-referred image data should preferably be 12 bits or more, and more preferably 16 bits or more.

To get natural spatial perception, the distance between “different viewpoints” (hereinafter referred to as “distance between viewpoints”, i.e. the distance between lens), is preferred to be about 6 through 7 cm, which is equal to the distance between human eyes, except for a special case. A special case refers to the case of emphasizing the three-dimensional effect of a subject arranged at a long distance from the photographing position, for example. In such a case, setting the distance between viewpoints to twice that distance provides the same effect as halving the distance to the subject. Conversely, when taking a close-in shot of a small subject, the three-dimensional effect can be improved by reducing the distance between viewpoints.

The distance to the main subject when acquiring a captured-image data set for stereoscopic vision display is preferred to be about 1 through 4 meters when the distance between viewpoints is 6 cm, as shown in FIG. 3. When this is turned into the angle (angle of convergence) up to the subject, we get about 1 through 4 degrees.

For example, when a small subject is placed at a distance of 10 cm, the distance between viewpoints must be adjusted not to exceed 6 mm in order to ensure that the angle up to the subject will be 4 degrees or less. Conversely, if a subject large enough to be observed is placed even at a distance of 100 meters, the distance between viewpoints must be adjusted to about 6 meters in order to ensure that the angle up to the subject is 4 degrees.

To get a sufficient three-dimensional effect using one image-capturing apparatus whose two image-capturing optical systems are arranged at an interval of about 6 cm, a subject is preferred to the one that can be photographed at a distance of 1 through 4 meters from the image-capturing apparatus.

“To output one captured-image data set from a plurality of captured-image data sets” is to process at least two captured-image data sets required for stereoscopic vision display by stereopair to get a predetermined file format in such a way that it can be handled as only one captured-image data set, except for stereoscopic vision display.

“To select at least one reference image data set” is to determine at least one captured-image data set for the display other than stereoscopic vision display or for hardcopy outputting, from at least two captured-image data sets required for stereoscopic vision display by stereopair.

“Differential image data” is defined as digital image data wherein parallax image data is held as difference between the reference image data selected from a plurality of captured-image data sets for stereoscopic vision display and other captured-image data. Thus in the case of a scene obtained by photographing a distant view as a subject, the differential image data exhibits a very small value.

“To extract the differential image data containing the difference between reference image data and other captured-image data” is to extract the parallax image data between the reference image data and other captured-image data. The following computation equation can be cited an example of processing.

In the description of the present specification, the captured-image data with respect to reference image data is called the parallax image data.

B=A1−A2 (Eq. 1)

where

A1: reference image data

A2: parallax image data (other captured-image data)

B: differential image data

“To attach to the reference image data” is to record to part of reference image data. FIG. 5(c) shows an example of a file format where data is recorded in separated file areas.

That “the attachment identifying information for indicating attachment of that differential image data is attached to the reference image data” is that the indicator showing the contents of captured-image data and additional information required for re-processing are recorded in the area different from where information on subject information is recorded. The attachment identifying information for indicating the attachment of differential image data is preferred to be recorded in the header area of reference image data as tag information. (See FIG. 5(a)).

When “inputted captured-image data” is scene-referred image data, the data is preferred to be converted into the “image data optimized for outputting on the output medium”, i.e. “image data for stereoscopic vision display”. The following describes the details of output-referred image data.

The “output-referred image data” (also referred to as “visual image referred image data”) denotes digital image data, which is generated by applying an “optimization processing”, so as to acquire an optimized image on such a display device as CRT, liquid crystal display and plasma display, or on such an outputting medium as silver halide photographic paper, inkjet paper and thermal printing paper. Incidentally, in the image-processing apparatus or image-recording apparatus, which inputs the scene-referred image data, the output-referred image data are generated by applying an optimization processing to the scene-referred image data for every display device and for every outputting medium.

As a concrete example of the abovementioned “optimization processing”, the conversion processing to the color gamut of the sRGB standard can be cited, when display is given on the CRT display monitor conforming to the sRGB standard. Accordingly, when the data is to be outputted on silver halide photographic paper, processing is provided in such a way that the optimum color reproduction can be gained within the color gamut of silver halide photographic paper. In addition to compression of the above-mentioned color gamut, compression of gradation from 16 to 8 bits, reduction in the number of output pixels, and processing in response to the output characteristics (LUT) of the output device are also included. Further, it goes without saying that such processing as noise control, sharpening, white balance adjustment, color saturation adjustment or dodging is carried out.

After generating the output-referred image data, the differential image data between scene-referred image data and output-referred image data is obtained, and may be attached to the output-referred image data, together with the differential image data of parallax image data. FIG. 5(b) shows an example of the file format for this case.

That “the reference image data is separated from the differential image data based on the attachment identifying information” is defined as the step of decoding the tag information of the reference image data, and reading the differential image data from a predetermined area of the file format, if the differential image data of the parallax image data is contained, thereby ensuring that image processing can be applied to the differential image data of the reference image data at any time.

That, “based on the separated reference image data and differential image data, the parallax image data is generated” means that the parallax image data forming a pair with the reference image data is generated. The following computation equation can be cited an example of processing.

A2=A1+B (Eq. 2)

where

A1: reference image data

A2: parallax image data

B: differential image data

That, “based on the reference image data and parallax image data, image data for stereoscopic vision display is generated” means that each image size is adjusted so that these two images will be kept at a distance of at least about 6 through 7 cm, equal to the distance between human eyes, and the digital image data for stereoscopic vision display of stereopair (hereinafter referred to as “image data for stereoscopic vision display” as being synonymous therewith) is prepared in such a way that the reference image and parallax image are arranged correctly in response to the observation conditions of the parallel method or cross method (FIG. 9).

The image-capturing apparatus of the present invention may contain, in addition to the digital camera, an analog camera using a color negative film, color reversal film and monochromic reversal film; a film scanning section for reading the frame image information of photographic photosensitive material to get digital image data; or a flatbad scanner for reading the image information reproduced on the silver halide photographic paper to get digital image data.

The “captured-image data” can be inputted by any of the commonly known portable “storage media” including the compact flash (registered trademark), memory stick, smart media, multi-media card, floppy (registered trademark) disk, magneto-optical disk (MO) and CD-R.

In another manner in which the invention is carried into practice, digital image data can be obtained from a remote site through such communications means as a network. Alternatively, digital image data can be directly sent through linkage of the image-capturing apparatus, image recording apparatus and image recording apparatus by wire.

In the image-capturing apparatus, image processing apparatus and image recording apparatus, the additional information of the Exif file may be used as the header recording information of the captured-image data.

The aforementioned additional information includes, for example, the tag information representing device type dependent information; information directly related to the camera type (device type) such as camera name and code number; setting of photographic conditions such as exposure time, shutter speed, f-stop number, ISO sensitivity, brightness value, subject distance range, light source, presence/absence of shooting in flash mode, subject range, white balance, zoom scaling factor, subject composition, photographic scene type, the amount of stroboscopic light source and photographic chroma; and information on subject type.

### BRIEF DESCRIPTION OF THE DRAWINGS

Other objects and advantages of the present invention will become apparent upon reading the following detailed description and upon reference to the drawings in which:

FIG. 1 is a block diagram representing the functional configuration of an image-capturing apparatus 30 of the present invention;

FIG. 2 is a block diagram representing the internal configuration of a first image-capturing section 21 and second image-capturing section 22 shown in FIG. 1;

FIG. 3 is a drawing representing the relationship between the distance to a desirable main subject and angle thereto when the distance between viewpoints is 6 cm;

FIG. 4 is a flowchart representing the processing of capturing and recording the image for stereoscopic vision display to be carried out under the control of a controller 11 shown in FIG. 1, in acquiring captured-image data for stereoscopic vision display;

FIG. 5(a) is a drawing representing the data configuration of a file generated by the image-capturing apparatus 30 and image processing apparatus 100;

FIG. 5(b) is a drawing representing the data configuration of a file generated by the image processing apparatus 200A;

FIG. 5(c) is a drawing representing an example of the step of attaching differential image data to reference image data;

FIG. 6 is a block diagram representing the functional configuration of the image processing apparatus 100 embodied in the present invention;

FIG. 7 is a flowchart showing the processing of reference image data output to be carried out through cooperation among various components of the image processing apparatus 100 shown in FIG. 6;

FIG. 8 is a block diagram representing the functional configuration of the image processing apparatus 200 embodied in the present invention;

FIG. 9 is a drawing representing an example of layout of the reference image and differential image in the image data for stereoscopic vision display;

FIG. 10 is a flowchart showing the processing (A) of generating the image data to be carried out through cooperation among various components of the image processing apparatus 200 shown in FIG. 8;

FIG. 11 is a block diagram representing the functional configuration of the image processing apparatus 200A embodied in the present invention;

FIG. 12 is a flowchart showing the processing B of generating the image data for stereoscopic vision display;

FIG. 13 is an external perspective view of the image recording apparatus 301 embodied in the present invention;

FIG. 14 is a drawing representing the internal configuration of the image recording apparatus 301 shown in FIG. 13;

FIG. 15 is a block diagram representing the functional configuration of the image processing apparatus 370 shown in FIG. 14; and

FIG. 16 is a flowchart showing the processing of forming the image data for stereoscopic vision display to be carried out through cooperation among various components of the image processing apparatus 301 shown in FIG. 14.

### DETAILED DESCRIPTION OF THE PREFERRED EMBODIMENT

The following describes the preferred embodiments of the present invention with reference to drawings:

<Configuration of Image-capturing Apparatus 30>

The configuration will be described in the first place.

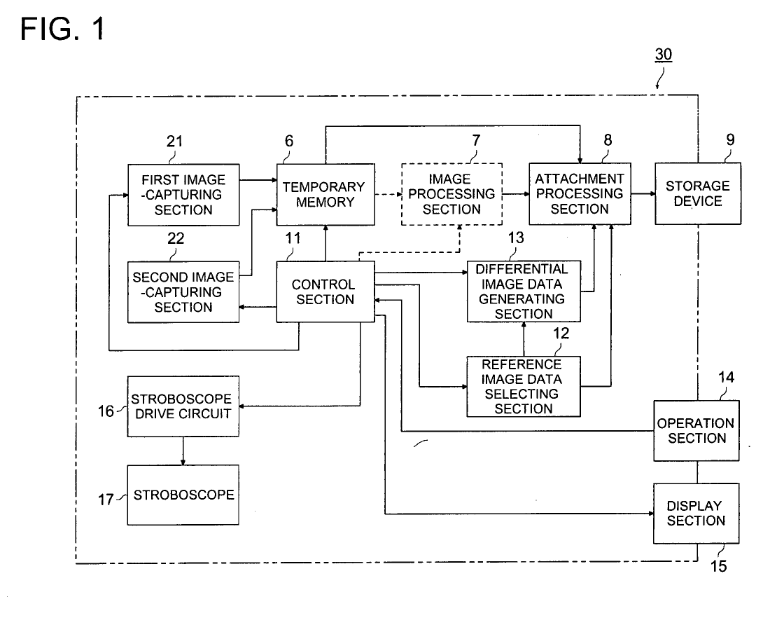

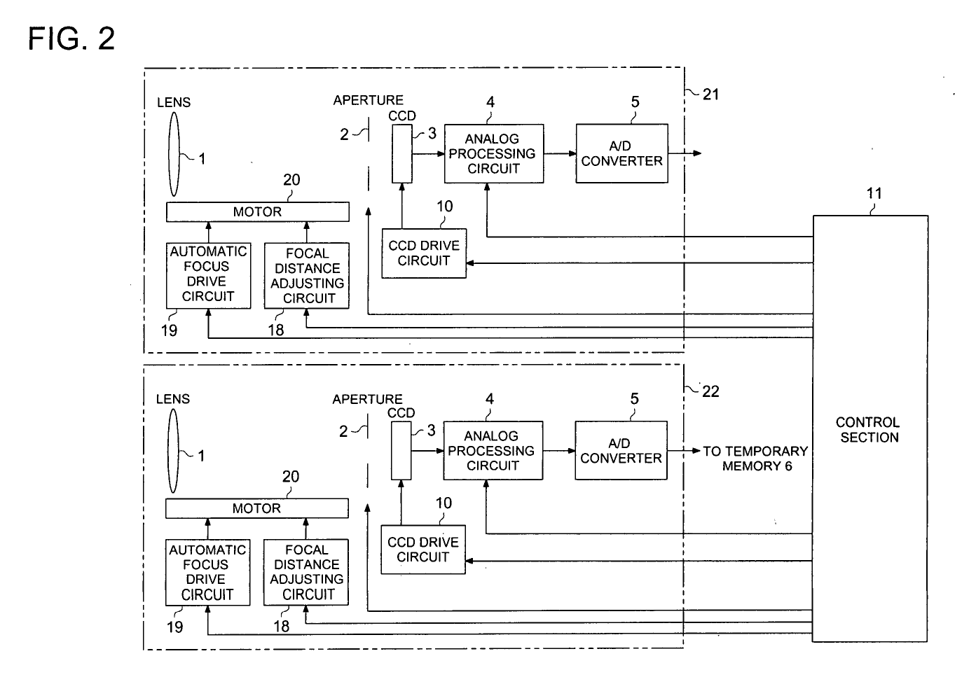

FIG. 1 is a block diagram representing the function configuration of an image-capturing apparatus 30 of the present invention. The image-capturing apparatus 30 is a digital camera capable of simultaneous or sequential photographing of one and the same subject from different viewpoints and recording a plurality of captured-image data sets for stereoscopic vision display. As shown in FIG. 1, the image-capturing apparatus 30 comprises a first image-capturing section 21, second image-capturing section 22, temporary memory 6, image processing section 7, attachment processing section 8, storage device 9, control section 11, reference image data selecting section 12, differential image data generating section 13, operation section 14, display section 15, stroboscope drive circuit 16, stroboscope 17, etc.

The first image-capturing section 21 and second image-capturing section 22 are located at a predetermined interval to photograph one and the same subject from different viewpoints, and each of them contains a lens 1, aperture 2, CCD (solid image-capturing device) 3, analog processing circuit 4, A/D converter 5, CCD drive circuit 10, focal distance adjusting circuit 18, automatic focus drive circuit 19, motor 20, etc. Photographing is controlled by the control section 11.

The lens 1 adjusts the focus and forms an optical image of a subject. The aperture 2 adjusts the amount of luminous flux having passed the lens 1. The CCD 3 provides photoelectric conversion of the light of the subject whose image is formed on the light receiving surface of the lens 1, into the electric signal (captured-image signal) in the amount corresponding to the amount of incoming light for each sensor inside the CCD 3. The CCD 3 is controlled by the timing pulse coming from the CCD drive circuit 10, whereby captured-image signals are sequentially outputted to the analog processing circuit 4.

The analog processing circuit 4 applies processing of R, G, B signal amplification and noise reduction to the captured-image signal inputted from the CCD 3. The A/D converter 5 converts the captured-image signal inputted from the analog processing circuit 4, into the digital captured-image data, and outputs it to the temporary memory 6.

The CCD drive circuit 10 outputs the timing pulse, based on the control signal outputted from the control section 11, and controls the drive of the CCD 3.

The focal distance adjusting circuit 18 controls the motor 20 for moving the lens 1 in response to the control signal from the control section 11, thereby adjusting the focal distance.

The automatic focus drive circuit 19 controls the motor 20 for moving the lens 1 in response to the control signal of the control section 11, thereby adjusting the focus.

To get natural spatial perception, the distance between the lens of the first image-capturing section 21 and second image-capturing section 22 (distance between viewpoints) n is preferred to be set at about 6 through 7 cm, which is equal to the distance between human eyes, except for a special case.

A special case refers to the case of emphasizing the three-dimensional effect of a subject arranged at a long distance from the image-capturing apparatus 30, for example. In such a case, setting the distance between viewpoints to twice that distance provides the same effect as halving the distance to the subject. Conversely, when taking a close-in shot of a small subject, the three-dimensional effect can be improved by reducing the distance between viewpoints.

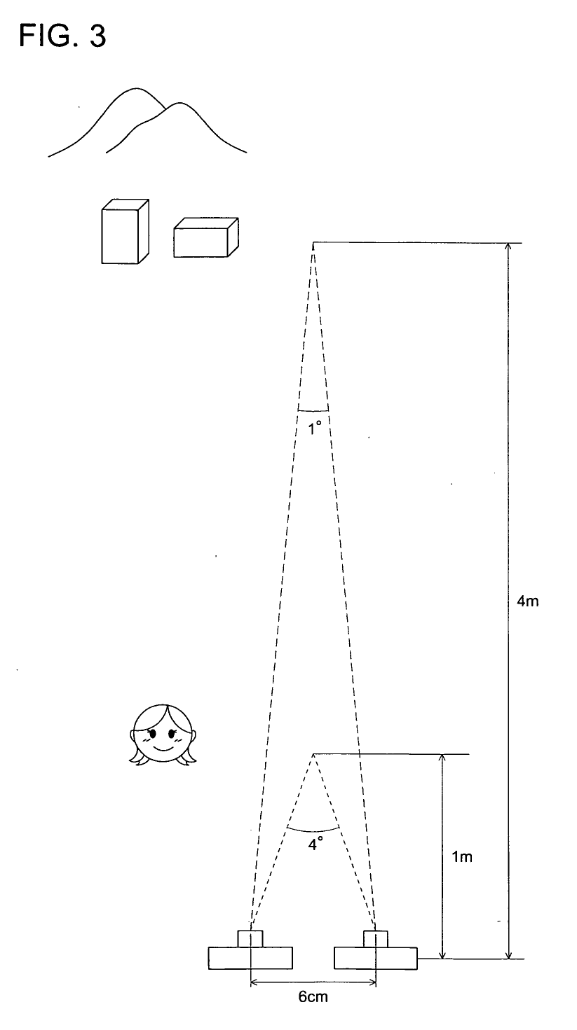

The distance to the main subject when acquiring a plurality of captured-image data sets for stereoscopic vision display is preferred to be about 1 through 4 meters, as shown in FIG. 3, when the distance between viewpoints is 6 cm. When this is turned into the angle (angle of convergence) up to the subject, we get about 1 through 4 degrees.

For example, when a small subject is placed at a distance of 10 cm, the distance between viewpoints must be adjusted not to exceed 6 mm in order to ensure that the angle up to the subject will be 4 degrees or less. Conversely, if a subject large enough to be observed is placed even at a distance of 100 meters, the distance between viewpoints must be adjusted to about 6 meters in order to ensure that the angle up to the subject is 4 degrees.

Thus, to get a sufficient three-dimensional effect when the first image-capturing section 21 and second image-capturing section 22 are arranged at an interval of about 6 cm, a subject is preferred to the one that can be photographed at a distance of 1 through 4 meters from the image-capturing apparatus.

The image-capturing apparatus 30 may be configured in such a way as to contain both the first image-capturing section 21 and second image-capturing section 22. Alternatively, one of the image-capturing section, for example, the second image-capturing section 22, may be removably mounted on the image-capturing apparatus 30 as an adaptor-equipped attachment, and may be installed through the adaptor when a plurality of captured-image data sets for stereoscopic vision display are to be photographed. Further, it is also possible to make such arrangements that the image-capturing section is slidable in the longitudinal direction of the image-capturing apparatus 30, whereby the distance between viewpoints is adjusted and a plurality of images having different distance between viewpoints are photographed.

The captured-image data obtained by the first image-capturing section 21 and second image-capturing section 22 is outputted to the temporary memory 6 such as a buffer memory, and is stored on a temporary basis.

The image processing section 7 applies processing of captured-image characteristics correction to each of the captured-image data sets stored in the temporary memory 6 to generate the scene-referred image data. The processing of captured-image characteristics correction includes the step of processing wherein signal intensity of each color channel based on the spectral sensitivity inherent to the image-capturing device is mapped into the standard color space such as scRGB, RIMM RGB or ERIMM RGB. In addition to the above, computation of frequency processing such as gradation conversion, smoothing, sharpening, noise elimination and moire elimination is carried out.

The image processing section 7 applies the processing of optimization for getting the optimum image in the display section 15, to the generated scene-referred image data, and generates the output-referred image data. Processing of optimization includes compression to the color-range suitable for the display section 15, such as sRGB, ROMM RGB (Reference Output Medium Metric RGB), gradation compression from 16 to 8 bits, reduction in the number of output pixels, and conformance of the display section 15 to the output characteristics (LUT). Further, image processing such as noise suppression, sharpening, color balance adjustment, chroma adjustment and dodging is also included. The image processing section 7 performs image size modification, trimming, aspect change and others. When the operation signal for specifying the output of scene-referred image data has been inputted from the operation section 14, generation of the output-referred image data in this control section 11 is omitted under the control of the control section 11.

The attachment processing section 8 records the differential image data generated by the differential image data generating section 13, on part of the reference image data selected by the reference image data selecting section 12, and attaches it, thereby creating an attached data file. At the same time, the attachment processing section 8 writes the attachment identifying information as tag information in the file header area, wherein the attachment identifying information indicates the differential image data is attached.

The storage device 9 is composed of a nonvolatile semiconductor memory and others, consisting of a storage medium such as memory card, mounted removably on the image-capturing apparatus 30, for recording captured-image data, and a storage device for storing the control program of the image-capturing apparatus 30 in a readable form.

The control section 11 consists of a CPU (Central Processing Unit) and others. It reads the control program of the image-capturing apparatus 30 stored in the storage device 9 and controls the entire image-capturing apparatus 30 according to the read-out program. To put it more specifically, the control section 11 controls the first image-capturing section 21 and second image-capturing section 22 and stroboscope drive circuit 16 in conformity to the operation signal from the operation section 14, whereby shots are taken.

When the output of the captured-image data for stereoscopic vision display by scene-referred image data has been specified by the operation section 14, the control section 11 starts image photographing and recording for stereoscopic vision display to be described later.

The reference image data selecting section 12 selects the reference image data, from a plurality of captured-image data sets for stereoscopic vision display, obtained by overheating, and outputs the result to the differential image data generating section 13 and attachment processing section 8.

The differential image data generating section 13 uses the following equation to extract the differential image data as the parallax image data between the captured-image data selected as the reference image data by the reference image data selecting section 12 and other captured-image data (called parallax image data), and outputs it to the attachment processing section 8.

where

A1: reference image data

A2: parallax image data

B: differential image data

B=A1−A2

The operation section 14 is provided with function buttons such as a release button (not illustrated), power on/off button and zoom button, and cursor keys. The operation signal corresponding to each button or key is outputted to the control section 11 as an input signal. Further, the operation section 14 has a touch panel covering the display screen of the display section 15, and detects the XY-coordinate of the power point on the display screen pressed by the finger or touch pen, using a voltage value. The detected position signal is outputted to the control section 11 as an operation signal.

The display section 15 displays the captured-image data through the control signal from the control section 11, and displays the display screen for the user of the image-capturing apparatus 30 to input the information, setting and conditions for confirming the setting and conditions on photographing.

When the subject brightness is low, the stroboscope drive circuit 16 drives and controls the stroboscope 17 through the control signal of the control section 11 so that a sufficient amount of light will be emitted.

The stroboscope 17 increases the battery voltage to a predetermined high level and stores it in the capacitor. It is then driven by the stroboscope drive circuit 16, whereby the X-tube is lighted by the electric charge stored in the capacitor, and fill light is emitted to the subject.

<Operation of Image-capturing Apparatus 30>

The following describes the operation:

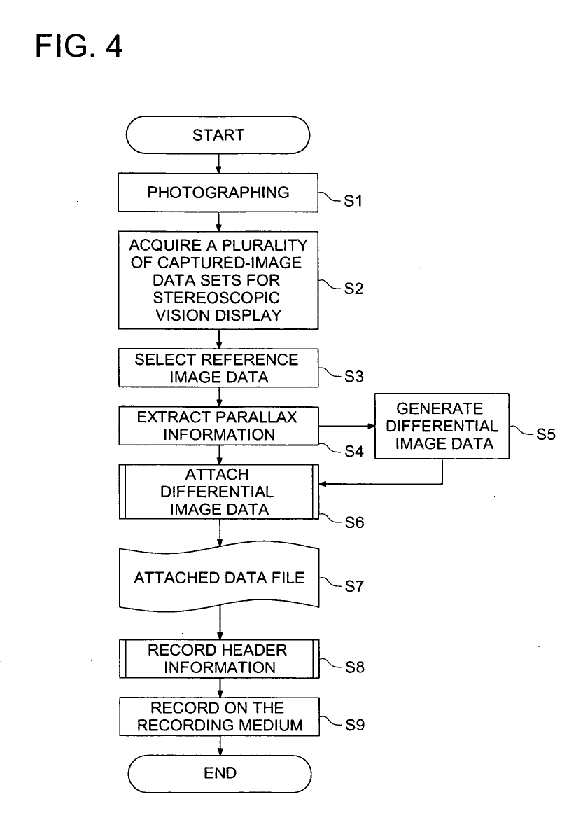

FIG. 4 is a flowchart representing the processing of capturing and recording the image for stereoscopic vision display to be carried out under the control of a controller 11 when the operation section 14 has set the output of the captured-image data of a plurality of captured-image data sets for stereoscopic vision display by the scene-referred image data, and the release switch has been depressed. The following describes the processing of capturing and recording the image for stereoscopic vision display, with respect to FIG. 4:

When the release button of the operation section 14 has been depressed, one and the same subject is photographed from different viewpoints by the first image-capturing section 21 and second image-capturing section 22 (Step S1). The image processing section 7 applies processing of captured-image characteristics correction to a plurality of captured-image data sets for stereoscopic vision display obtained by this photographing, and the data is mapped into the standard color space of the RIMM RGB or ERIMM RGB. The data is converted into the scene-referred image data and is outputted into the differential image data generating section 13 (Step S2).

The reference image data selecting section 12 allows the reference image data to be selected from a plurality of captured-image data sets for stereoscopic vision display obtained by photographing (scene-referred image data) (Step S3). It is also possible to arrange the following configuration: Through the operation section 14, the user enters the information on his preference as to which of the two image-capturing sections should be used to photograph the captured-image data to get the reference image data. Based on this inputted information, the reference image data can be selected. Alternatively, setting is made in advance so that the captured-image data photographed by the first image-capturing section 21, for example, is used as a reference image data, whereby processing is carried out automatically. Either of these configurations can be utilized.

The differential image data generating section 13 gets the difference between the selected reference image data and parallax image data as the other captured-image data, whereby parallax image data is extracted (Step S4), and the differential image data is generated (Step S5). The reference image data and generated differential image data are outputted to the attachment processing section 8, and the difference is recorded on part of the reference image data. This allows the differential image data to be attached to the reference image data (Step S6), which is compressed in JPEG format. The attached data file of the format conforming to the DCF (Design rule for Camera File system) is generated (Step S7). Further, the attachment identifying information as tag information is recorded on the header area of the file of reference image data with differential image data attached thereto (Step S8), and is recorded on the storage medium of the storage device 9 (Step S9). The attachment identifying information as used herein refers to the additional information required for reprocessing, such as a flag indicating attachment of the differential image data and information showing the area of the differential image data.

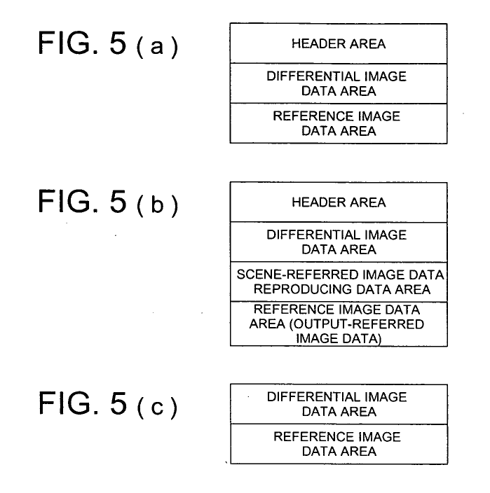

FIG. 5(a) is a drawing representing the data configuration of a data file recorded on the storage medium of the storage device 9 in (Step S9). As shown in FIG. 5(a), the data file recorded on the storage medium contains the reference image data area, differential image data area and header area. This storage area is taken out of the image-capturing apparatus 30 and is loaded on the image processing apparatus and image recording apparatus, whereby the reference image data and differential image data can be outputted to an external apparatus to be used thereon.

As described above, the image-capturing apparatus 30 captures a plurality of captured-image data sets for stereoscopic vision display and selects one reference image data therefrom. Parallax information between this reference image data and parallax image data corresponding thereto is extracted, and is attached to the reference image data as differential image data. This arrangement allows a plurality of captured-image data sets for stereoscopic vision display to be handled as a single captured-image data set, and enables saving of data in the same file format as that of the normal captured-image data, not intended for stereoscopic vision display. It also enables file names to be set. Since the attachment identifying information is recorded in the header area of the file, search efficiency is improved when a captured-image data file for stereoscopic vision is searched from among a plurality of files.

As described above, the image-capturing apparatus 30 improves compatibility between captured-image data for stereoscopic vision display and normal captured-image data, and general versatility and convenience of the captured-image data for stereoscopic vision display. General versatility and convenience of the captured-image data for stereoscopic vision display can be further enhanced by recording the reference image data and differential image data in the file format conforming to the DCF standard.

The differential image data is attached to the reference image data, without the reference image data and parallax image data corresponding thereto being saved directly. This arrangement reduces the capacity of the file to be used, and substantially increases the number of sheets to be photographed. Further, the reference image data and parallax image data are recorded as scene-referred image data; this method prevents loss of information on a wide color range and brightness range obtained by the image-capturing apparatus 30.

In the aforementioned embodiment, the attachment identifying information is recorded in the header area of the file as tag information. The header area is preferred to record the information on the number of viewpoints based on which differential image data is formed. It is also preferred to record the distance between viewpoints of each differential image data with respect to reference image data.

In the image-capturing apparatus having no function of selecting the reference image data and the differential image data to the reference image data as in the present invention, the captured-image data for stereoscopic vision display having been photographed is preferred to be recorded in the format conforming to the DCF standard, if captured-image data for stereoscopic vision display can be photographed. It is also preferred to use the head area to record the information useful when using the captured-image data for stereoscopic vision display, including the information on the number of viewpoints based on which captured-image data is formed, the information on the distance between viewpoints of each captured-image data, and the information specifying the captured-image data to used when outputted as a two-dimensional image (2D-image).

An example of recording the captured-image data as scene-referred image data in the storage medium has been shown in the aforementioned embodiment. It is also possible to arrange such a configuration that processing of optimization is applied to the captured-image data by the image processing section 7 to generate output-referred image data, and the reference image data is selected for this output-referred image data, whereby differential image data is generated and attached.

<Configuration of Image Recording Apparatus 100>

The following describes an embodiment of the image recording apparatus of the present invention:

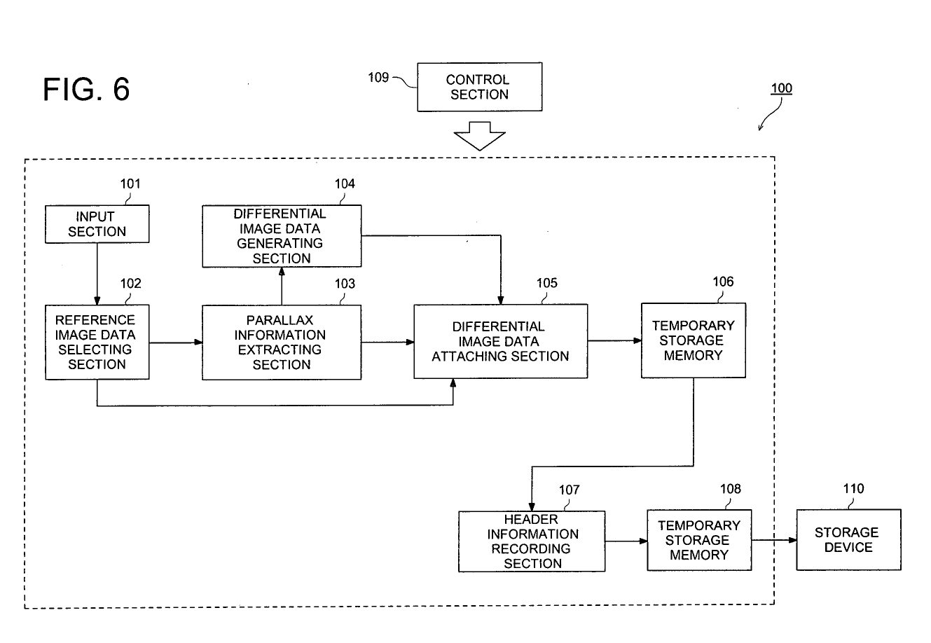

FIG. 6 is a block diagram representing the functional configuration of the image processing apparatus 100 of the present invention. As shown in FIG. 6, the image processing apparatus 100 includes an input section 101, reference image data selecting section 102, parallax information extracting section 103, differential image data generating section 104, differential image data attaching section 105, temporary storage memory 106, header information recording section 107, and temporary storage memory 108. It can also be connected with a storage device 110. The aforementioned components are operated under the general control of the control section 109.

The input section 101 is provided with a storage medium loading section (not illustrated). When this loading section is loaded with the storage medium recording a plurality of captured-image data sets for stereoscopic vision display recorded by such an image-capturing apparatus as a digital camera, the input section 101 reads the data and inputs it to the reference image data selecting section 102. According to the description in the present embodiment, the input section 101 reads the data from the loaded storage medium and inputs it. However, it is also possible to make such arrangements that data communications cable and wireless or wired communications means are provided and data is inputted through this communications means.

The reference image data selecting section 102 selects the reference image data from a plurality of captured-image data sets for stereoscopic vision display inputted from the input section 101. This selection can be made manually by the user. Alternatively, it can be automatically selected according to the definition made in advance in such a way that the image captured from the right of the subject is selected when there are two captured-image data sets, and the image captured at the center (from the front surface) is selected when there are three. To enable automatic selection, it is necessary to provide a means for identifying the position from which the subject is photographed to get each of the captured-image data sets. Such an identifying means includes the header information of a file, for example.

The parallax information extracting section 103 corresponds to a differential image data extracting section. The following equation is used to extract the differential image data between the reference image data selected by the reference image data selecting section 102, and parallax image data other captured-image data as captured-image data forming a pair with the reference image data in the case of stereoscopic vision display. The extracted differential image data is outputted to the differential image data generating section 104.

where

A1: reference image data

A2: parallax image data

B: differential image data

B=A1−A2

The differential image data generating section 104 processes the differential image data extracted from the parallax information extracting section 103 to form it into the differential image data to be attached.

The differential image data attaching section 105 attaches the processed differential image data to the reference image data as part of the reference image data, and compresses the reference image data with the differential image data attached thereto, according to the JPEG method. It then generates an attached data file in a file format conforming to the DCF (Design rule for Camera File system) and outputs it to the temporary storage memory 106.

The temporary storage memory 106 temporarily stores the attached data file outputted from the differential image data attaching section 105.

The header information recording section 107 is an information attaching means. It records the attachment identifying information for indicating attachment of the differential image data, as tag information, on the header area of the reference image data with the differential image data attached thereto. The attachment identifying information as used herein refers to the additional information required for reprocessing, such as a flag indicating attachment of the differential image data and information showing the area of the differential image data. The reference image data file having completed recording of information on the header area is temporarily stored in the temporary storage memory 108, and is then outputted to the storage device 110 as a single captured-image data set.

The aforementioned classification of the reference image data selecting section 102, parallax information extracting section 103, differential image data generating section 104, differential image data attaching section 105 and header information recording section 107 need not necessarily been realized as independent physical devices. It can be realized, for example, as a classification of the types of software processing in a single CPU.

<Operation of Image Processing Apparatus 100>

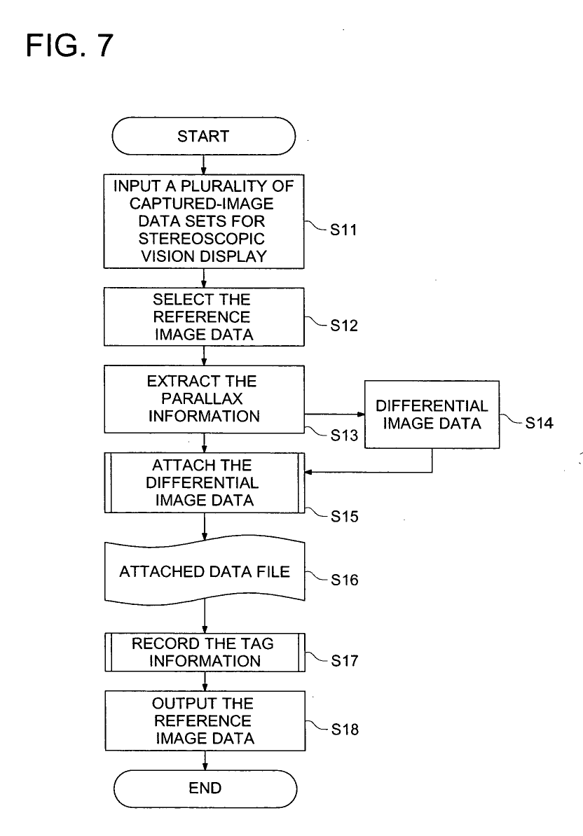

FIG. 7 is a flowchart showing the processing of reference image data output to be carried out through cooperation among various components of the image processing apparatus 100. Referring to FIG. 7, the following describes the operation of the image processing apparatus 100.

When the storage medium recording a plurality of captured-image data sets for stereoscopic vision display has been loaded, the input section 101 inputs the a plurality of captured-image data sets recorded on the storage medium (Step S11). The captured-image data to be inputted can be either the scene-referred image data or output-referred image data. The reference image data selecting section 102 selects the reference image data from the a plurality of captured-image data sets having been input (Step S12). Then the parallax information extracting section 103 gets the difference between the selected reference image data and parallax image data as inputted other captured-image data, whereby parallax information is extracted (Step S13). The extracted parallax information is processed as parallax image data (Step S14).

The generated differential image data and reference are outputted to the differential image data attaching section 105 and the differential image data is recorded on part of the reference image data. The differential image data is attached to the reference image data (Step S15), and is compressed in the JPEG method, thereby generating an attached data file in the file format conforming to the DCF standard (Step S16). Further, the attachment identifying information is recorded on the header area of the reference image data with the differential image data attached thereto, as tag information (Step S17). The reference image data is outputted to the storage device 110 as a single captured-image data set (Step S18).

The aforementioned processing of reference image data outputting allows a file having the same data structure as that shown in FIG. 5(a), to be outputted to the storage device 110.

As described above, the image processing apparatus 100 selects one reference image data set from a plurality of inputted captured-image data sets for stereoscopic vision, and extracts the parallax information between this reference image data and other parallax image data forming a pair with the reference image data for stereoscopic vision display, thereby creating a file attached to the reference image data as differential image data. At the same time, the information indicating the attachment of differential image data is recorded on the header area of the file as tag information.

This arrangement allows a plurality of captured-image data sets for stereoscopic vision display to be handled as a single captured-image data set, and enables saving of data in the same file format as that of the normal captured-image data, not intended for stereoscopic vision display. It also enables file names to be set. Since the attachment identifying information is recorded as tag formation of the file, search efficiency is improved when a captured-image data file for stereoscopic vision is searched from among a plurality of files. Further, since the captured-image data file for stereoscopic vision and the normal captured-image data file by referring to the header area can be automatically identified, effective printing is ensured even if they are mixed with each other. Using an image recording apparatus (printer) incompatible with stereoscopic vision display, normal 2D photographic printing is possible based on captured-image data for stereoscopic vision display.

As described above, the image processing apparatus 100 improves compatibility between the captured-image data for stereoscopic vision display and the normal captured-image data, and upgrades the versatility and convenience of the captured-image data for stereoscopic vision display.

Further, the image processing apparatus 100 eliminates the need of selecting the reference image data in the image-capturing apparatus, generating the differential image data, and attaching the differential image data to the reference image data, thereby substantially reducing the processing load, hence, battery power consumption, while increasing the number of sheets to be photographed. It also reduces the capacity of the storage device required to save the captured-image data for stereoscopic vision display.

<Configuration of Image-capturing Apparatus 200>

The following describes another embodiment of the image recording apparatus of the present invention:

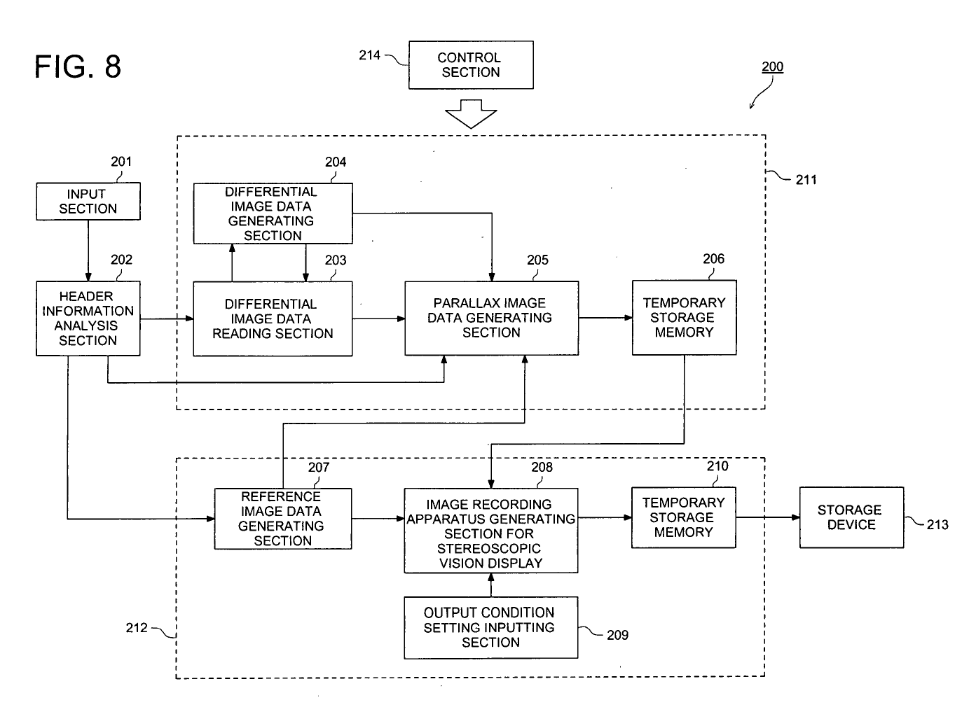

FIG. 8 is a block diagram representing the functional configuration of the image processing apparatus 200. As shown in FIG. 8, the image processing apparatus 200 comprises an input section 201, a header information analysis section 202, a first processing section 211 for generating the parallax image data from the inputted captured-image data and a second processing section 212 for generating the image data for stereoscopic vision display from the reference image data and parallax image data. The first processing section 211 and second processing section 212 are each connected with a header information analysis section 202, and the second processing section 212 can be connected with a storage device 213. The aforementioned components are operated under the general control of a control section 214.

The input section 201 is provided with a storage medium loading section (not illustrated). When this loading section is loaded with the storage medium recording the data file of the captured-image data (reference image data, with differential image data attached thereto, recording the attachment identifying information for indicating attachment of the differential image data to the header area, as tag information) recorded by the aforementioned image-capturing apparatus 30 or image processing apparatus 100, the input section 201 reads the file stored in the storage medium and inputs it to the header information analysis section 202. According to the description in the present embodiment, the input section 201 reads the data from the loaded storage medium and inputs it. However, it is also possible to make such arrangements that data communications cable and wireless or wired communications means are provided and data is inputted through this communications means.

The header information analysis section 202, as an identification means, analyzes the header information (tag information in the header area) in the file format of the reference image data inputted from the input section 201, and identifies the attachment identifying information. It then outputs the result to a differential image data reading section 203, parallax image data generating section 205 and reference image data generating section 207.

As shown in FIG. 8, the first processing section 211 contains the differential image data reading section 203, differential image data generating section 204, parallax image data generating section 205 and temporary storage memory 206.

The differential image data reading section 203 as a separating means reads the differential image data as parallax image data from a predetermined area of the inputted area, based on the result of identifying the attachment identifying information as analyzed by the header information analysis section 202, and separates the reference image data from the differential image data. The differential image data generating section 204 processes the read differential image data so that it can be subjected to image processing.

From the differential image data and reference image data, the parallax image data generating section 205 generates the parallax image data forming a pair with the reference image data in stereoscopic vision display. The parallax image data is generated from the following equation:

where

A1: reference image data

A2: parallax image data

B: differential image data

A2=A1+B

The temporary storage memory 206 temporarily stores the parallax image data generated from the parallax image data generating section 205.

As shown in FIG. 8, the second processing section 212 consists of a reference image data generating section 207, image recording apparatus generating section 208 for stereoscopic vision display, output condition setting inputting section 209 and temporary storage memory 210.

The reference image data generating section 207 reads the reference image data from the inputted data file and processes it so that it can be subjected to image processing.

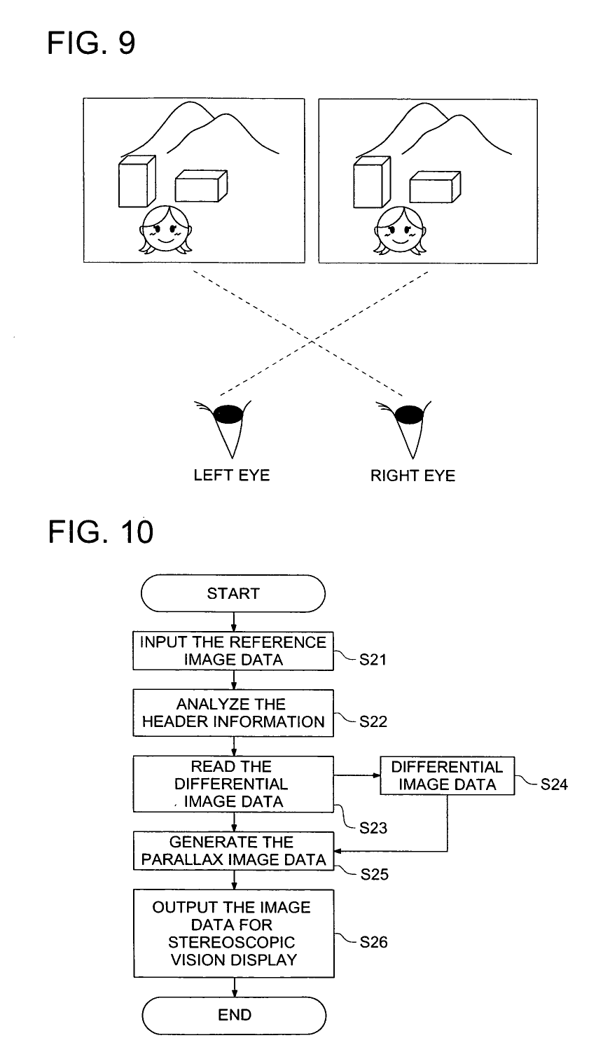

The image recording apparatus generating section 208 for stereoscopic vision display generates the image for stereoscopic vision display from the reference image data and the parallax image data stored in the temporary storage memory 206, according to the output condition setting inputted from the output condition setting inputting section 209. To put it more specifically, the size of each image is adjusted in such a way that the distance between viewpoints of two images—the reference image and parallax image—will be kept at a distance of at least about 6 through 7 cm, which is equal to the distance between human eyes, as shown in FIG. 9, and the image data for stereoscopic vision display is generated in such a way that the images are correctly arranged on the plane according to the observation conditions of the parallel method or cross method.

The output condition setting inputting section 209 comprises such a user interface as a keyboard or a touch panel arranged on the LCD. When the information on the output setting (e.g. device type of the output destination and output size) of the image data for stereoscopic vision display has been inputted, the output condition setting inputting section 209 outputs this information to the image recording apparatus generating section 208 for stereoscopic vision display.

The temporary storage memory 210 temporarily stores the image data for stereoscopic vision display generated by the image recording apparatus generating section 208 for stereoscopic vision display. The image data for stereoscopic vision display temporarily stored in the temporary storage memory 210 is outputted to the storage device 213.

The aforementioned classification of the header information analysis section 202, differential image data reading section 203, differential image data generating section 204, parallax image data generating section, 205 reference image data generating section 207, and image recording apparatus generating section 208 for stereoscopic vision display need not necessarily been realized as independent physical devices. It can be realized, for example, as a classification of the types of software processing in a single CPU.

<Operation of Image Processing Apparatus 200>

FIG. 10 is a flowchart showing the processing of image data generation A to be carried out through cooperation among various components of the image processing apparatus 200. The following describes the operation of the image processing apparatus 200, with respect to FIG. 10:

When the storage medium loading section is loaded with a storage medium recording the file of reference image data shown in FIG. 5(a), the input section 201 inputs the reference image data recorded on the storage medium (Step S21). Then the tag information of the reference image data file is analyzed by the header information analysis section 202, and the attachment identifying information is identified (Step S22). The differential image data reading section 203 reads the differential image data as parallax image data from a predetermined area of the file, based on the result of the analysis by the header information analysis section 202, and the reference image data is separated from the differential image data (Step S23). Processing is applied to the data by the differential image data generating section 204, thereby generating the differential image data that can be subjected to image processing (Step S24).

The parallax image data generating section 205 generates the parallax image data from the reference image data and differential image data (Step S25). Based on the output conditions inputted from the output condition setting inputting section 209, the image recording apparatus generating section 208 for stereoscopic vision display makes adjustment in such a way that the size and layout of two images—reference image data and generated parallax image data—will be best suited for stereoscopic vision display. Then the data is outputted to the storage device 213 as one image data set for stereoscopic vision display through the temporary storage memory 210 (Step S26).

As described above, when the attachment identifying information recorded in the header area of the inputted data file has been identified by the analysis of the header information analysis section 202, the image processing apparatus 200 allows the differential image data reading section 203 to read the differential image data from a predetermined area of the reference image data file, and the reference image data is separated from the differential image data are separated. The parallax image data forming a pair with the reference image data is generated in stereoscopic vision display, from the reference image data and differential image data. Adjustment is made in such a way that the size and layout of two images—reference image data and generated parallax image data—will be best suited for stereoscopic vision display. Then image data for stereoscopic vision display is generated and outputted to the storage device 213.

Thus, this arrangement makes it possible to automatically identify that the inputted data is the reference image data for stereoscopic vision display with the differential image data attached thereto, and permits the image data for stereoscopic vision display to be generated from the reference image data and differential image data. To be more specific, this arrangement makes it possible to automatically identify that the file of the reference image data having the data structure generated by the image-capturing apparatus 30 or image processing apparatus 100 has been inputted, and to generate the image data for stereoscopic vision display. This function reduces the load of processing by an image recording apparatus as a printer when the image data for stereoscopic vision display is formed on the output medium by the image recording apparatus and is outputted.

<Configuration of Image-capturing Apparatus 200A>

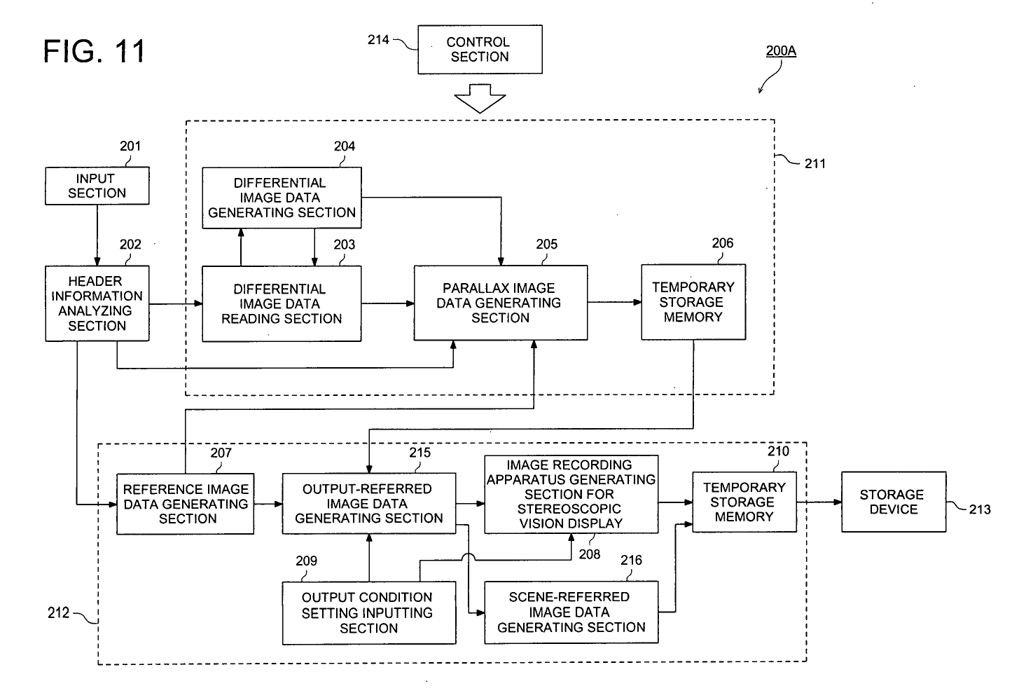

The following describes the image-capturing apparatus 200A capable of processing suitable for the case where the inputted reference image data is the scene-referred image data. FIG. 11 shows the functional configuration of the image processing apparatus 200A.

As shown in FIG. 11, the image-capturing apparatus 200A contains an output-referred image data generating section 215 and a scene-referred image data generating section 216 in addition to the aforementioned configuration of the image processing apparatus 200.

Based on the information inputted from the output condition setting inputting section 209, the output-referred image data generating section 215 applies the processing of optimization to both the reference image data as the scene-referred image data inputted from the reference image data generating section 207, and the parallax image data of the scene-referred image data generated by the first processing section 211 in such a way that the optimum output-referred image can be obtained on the output medium (CRT, liquid crystal display, plasma display, silver halide photographic paper, ink jet paper, thermal printer paper, etc.).

The scene-referred image data generating section 216 calculates the difference between the reference image data of the scene-referred image data and the reference image data converted into the output-referred image data, and extracts the differential data for scene-referred image data reproduction (hereinafter referred to as “scene-referred image data reproducing data”). Then it creates an attached data file by attaching the differential image data and extracted scene-referred image data reproducing data. At the same time, it records in the header area of the generated file the information indicating that the attachment identifying information and reference image data are output-referred image data, and the information showing that the scene-referred image data reproducing data is attached.

The image-capturing apparatus 200A has the same configuration as the image processing apparatus 200, and will not be described to avoid duplication.

<Operation of Image Processing Apparatus 200A>

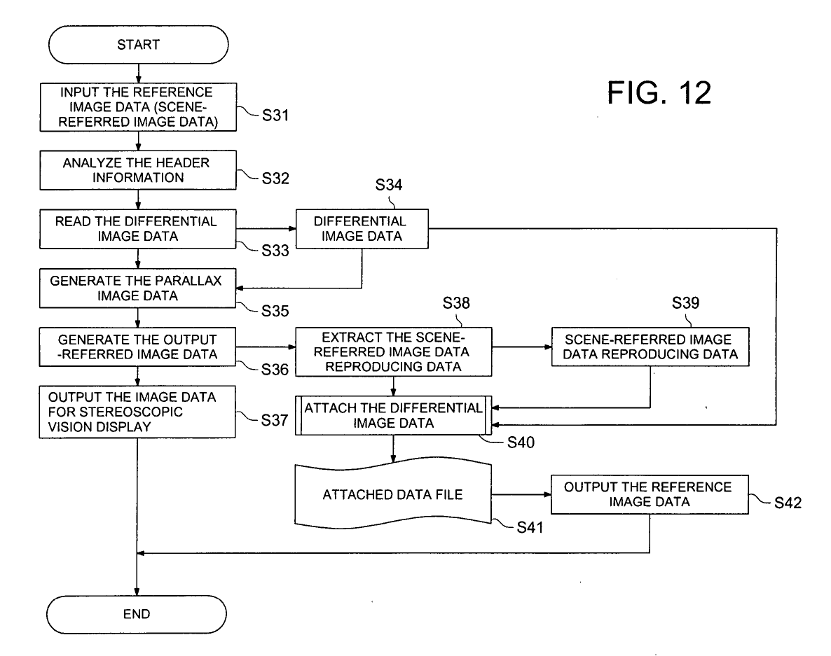

FIG. 12 is a flowchart showing the processing B of generating the image data for stereoscopic vision display to be carried out through cooperation among various components of the image processing apparatus 200A. The following describes the operation of the image-capturing apparatus 200A with reference to FIG. 12:

When the storage medium recording the file of the reference image data of the scene-referred image data has been loaded, the reference image data recorded in the storage medium is inputted by the input section 201 (Step S31). Then the tag information in the header area of the file of the reference image data is analyzed by the header information analysis section 202, and the attachment identifying information is identified (Step S32). The differential image data reading section 203 reads the differential image data from a predetermined area of the file, based on the result of the analysis by the header information analysis section 202, and the reference image data is separated from the differential image data (Step S33). Processing is applied to the data by the differential image data generating section 204, thereby generating the differential image data that can be subjected to image processing (Step S34).

The parallax image data generating section 205 generates the parallax image data from the reference image data and differential image data (Step S35). Based on the output conditions inputted from the output condition setting inputting section 209, the output-referred image data generating section 215 applies processing of optimization to each of the reference image data of the scene-referred image data and parallax image data in such a way that the optimum output-referred image can be obtained on the output medium, and the data is converted into the output-referred image data (Step S36).

Based on the output conditions inputted by the output condition setting inputting section 209, the reference image data and differential image data converted into output-referred image data are adjusted by the image recording apparatus generating section 208 for stereoscopic vision display in such a way that the size and layout of two images—reference image and generated parallax image—are optimized to stereoscopic vision display of stereopair. Then the data is outputted to the storage device 213 as one image data set for stereoscopic vision display through the temporary storage memory 210 (Step S37).

The scene-referred image data generating section 216 extracts the differential image data between the reference image data of the scene-referred image data and reference image data converted to the output-referred image data (Step S38), and scene-referred image data reproducing data is generated (Step S39). The differential information, i.e. the extracted scene-referred image data reproducing data and differential image data generated in Step S34 are attached to the reference image data of the output-referred image data (Step S40). Further, attachment identifying information, information for showing that the reference image data is output-referred image data, and information for showing that scene-referred image data reproducing data is attached, are attached to the header area of the generated file as tag information, whereby attached data file is created (Step S41). The data as the reference image data of output-referred image data is then outputted to the storage device 213 through the temporary storage memory (Step S42).

FIG. 5(b) shows the data configuration of a data file generated by the image processing apparatus 200A. As shown in FIG. 5(b), the image-capturing apparatus 200A is capable of generating a data file containing a reference image data area, scene-referred image data reproducing data area, differential image data area and header area.

As described above, the image-capturing apparatus 200A is capable of generating the image data for stereoscopic vision display optimized so as to provide the optimum image on the output medium, from the reference image data of the scene-referred image data. It also generates a file having the scene-referred image data reproducing data and differential image data for generating the parallax image data attached to the reference image data converted to the output-referred image data. Further, the image-capturing apparatus 200A allows attachment identifying information, information for showing that the reference image data is output-referred image data, and information for showing that scene-referred image data reproducing data is attached, to be attached to the header area of the generated file as tag information. This arrangement permits another image processing apparatus or image recording apparatus to generate the image data for stereoscopic vision display optimized to meet the output conditions, from the reference image data of the output-referred image data.

<Configuration of Image Recording Apparatus 301>

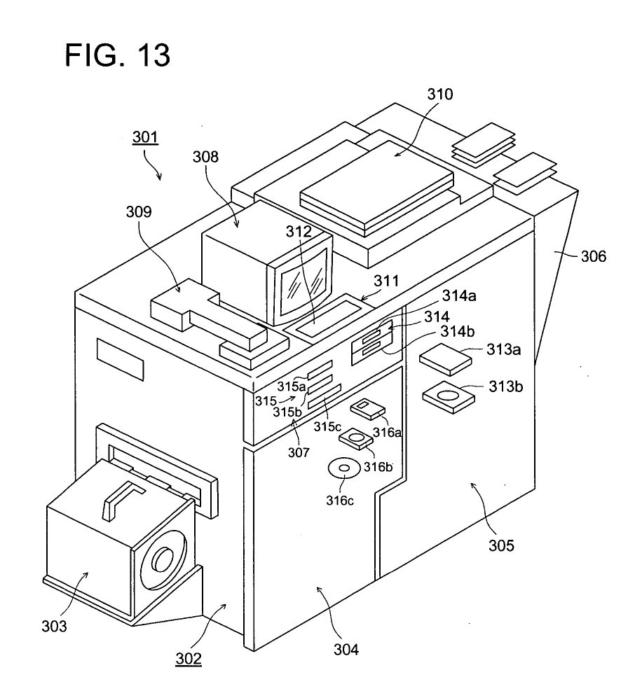

The following describes the preferred embodiments of the image recording apparatus of the present invention: FIG. 13 is an external perspective view representing an image recording apparatus 301 of the present invention. The image recording apparatus 301 in the present embodiment provides an example of the image recording apparatus equipped with a CRT display monitor as a display device and an output device using silver halide photographic paper as an output media.

In the image recording apparatus 301, a magazine loading section 303 is installed on the left side surface of the main unit 302. An exposure processing section 304 for causing the silver halide photographic paper as an output medium to be exposed to light, and a print creating section 305 for creating a print by developing and drying the exposed silver halide photographic paper are installed inside the main unit 302. The created print is ejected onto the tray 306 mounted on the right side of the main unit 302. Further, a control section 307 is provided on the upward position of the exposure processing section 304 inside the main unit 302.

A CRT 308 is arranged on the top of the main unit 302. It has the function of display means for displaying on the screen the image of the image information to be printed. A film scanner 309 as a transparent document reader is mounted on the left of the CRT 308, and a reflected document input apparatus 310 is arranged on the right.

One of the documents read from the film scanner 309 and reflected document input apparatus 310 is a photosensitive material. The photographic material includes a color negative, color reversal film, black-and-white negative, black-and-white reversal film. Frame image information captured by an analog camera is recorded on the photographic material. The film scanner of the film scanner 309 converts this recorded frame image information into digital image data and creates frame image data. When the photographic material is color paper as silver halide photographic paper, it can be converted into frame image data by the flat head scanner of the reflected document input apparatus 310.

An image reader 314 is mounted where the control section 307 of the main unit 302 is located. The image reader 314 is provided with a PC card adaptor 314a and a floppy (registered trademark) disk adaptor 314b to ensure that a PC card 313a and floppy disk 313b can be inserted into position. The PC card 313a has a memory where multiple items of frame image data (captured image data) obtained by photographing with a digital camera are stored. The floppy disk 313b stores multiple items of frame image data obtained by photographing with a digital camera.

An operation section 311 is arranged forwardly of the CRT 308. This operation section 311 is equipped with an information input section 312, which consists of a touch panel and others.

The recording medium storing the frame image data of the present invention other than the above-mentioned data includes a multimedia card, memory stock, MD data and CD-ROM. The operation section 311, CRT 308, film scanner 309, reflected document input apparatus 310 and image reader 314 is mounted integrally on the main unit 302. Any one of them can be installed as a separate unit.

An image write section 315 is mounted where the control section 307 of the main unit 302 is located. The image write section 315 is equipped with a floppy disk adaptor 315a, MO adaptor 315b, and optical disk adaptor 315c so that an FD 316a, MO 316b and optical disk 316c can be inserted into position, and image information can be written on the recording medium.

Further, the control section 307 provided with communication means 340, 341. It receives image data representing the captured image and print instruction directly from another computer in the facilities or a remote computer through the Internet, and is capable of functioning as a so-called network image output apparatus.

<Internal Configuration of Image Recording Apparatus 301>

The following describes the internal structure of the image recording apparatus 301.

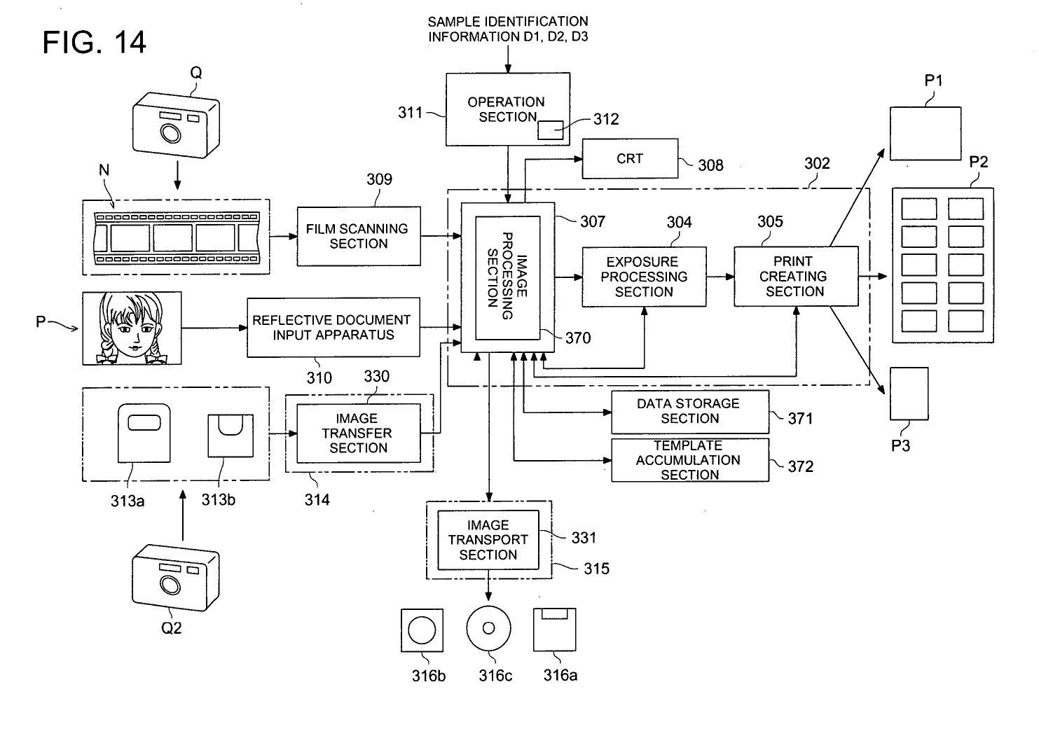

FIG. 14 is a block diagram representing the internal configuration of the image recording apparatus 301.

The control section 307 of the image recording apparatus 301 comprises a CPU (Central Processing Unit) and memory section. The CPU reads the various types of control programs stored in the memory section and centrally controls the components constituting the image recording apparatus 301 in conformity to the control program.

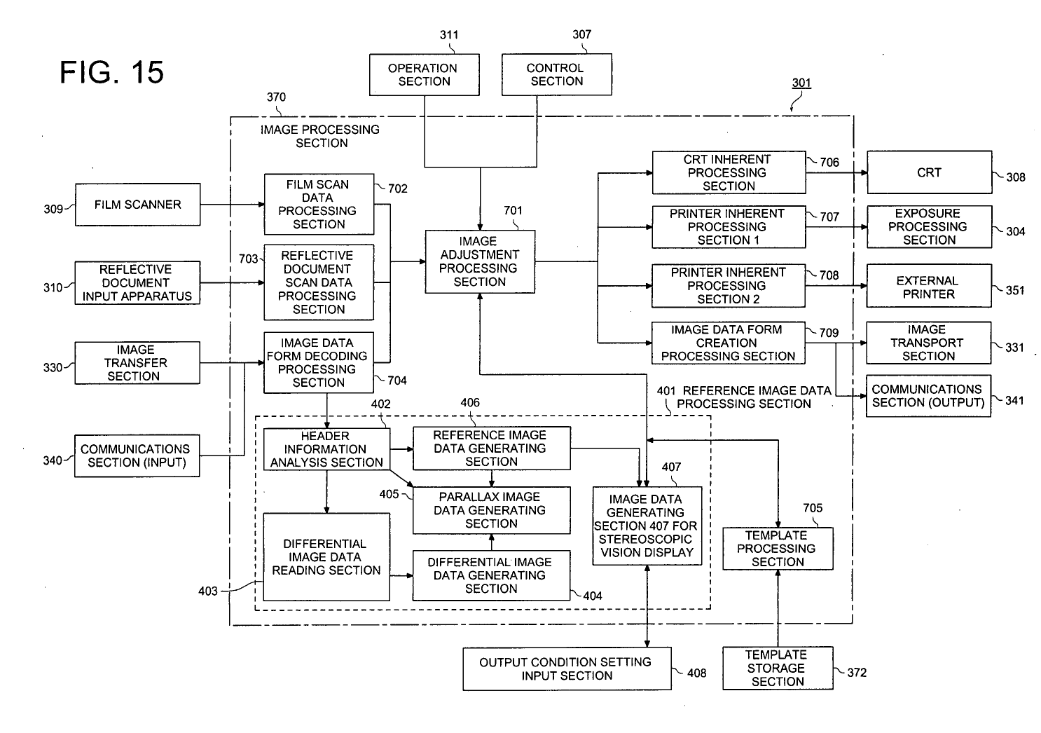

The control section 307 has an image processing section 370. Image processing is applied to: the image data gained by allowing the document image to be read by the film scanner 309 and reflected document input apparatus 310 based on the input signal from the information input means 312 of the operation section 311; the image data read from the image reader 314; and the image data inputted from the external equipment through and communications means (input) 340 (illustrated in FIG. 15). In the image processing apparatus 370, conversion processing in conformity to the output format is applied to the image data subjected to image processing, and the result is output as prints P1, P2 and P3 or by the monitor 308, image write section 315 and communications section (output) 341.

The operation section 311 is provided with an information input section 312. The information input section 312 comprises, for instance, a touch panel, and the signal of depressing the information input section 312 is outputted to the control section 307 as an input signal. It is also possible to arrange such a configuration that the operation section 311 is equipped with a keyboard or mouse.

The film scanner 309 reads the frame image data from the developed negative film N gained by an analog camera. From the reflected document input apparatus 310, the film scanner 309 reads the frame image data from the print P subjected to the processing of development with the frame image printed on the color paper as silver halide photographic paper.

The image reader 314 has a function of reading the frame image data of the PC card 313a and floppy disk 313b photographed and stored by the digital camera. Namely, the image reader 314 is equipped with a PC card adaptor and floppy disk adaptor as image transfer sections 330. It reads the frame image data recorded on the PC card 313a and floppy disk 313b mounted on the floppy disk adaptor 314b, and transfers it to the control section 307. A PC card reader or a PC cad slot, for example, is used as the PC card adaptor 314a.

The data storage section 371 memorizes image information and its corresponding order information (information on the number of prints to be created from the image of a particular frame) and stores them sequentially.

The template memory section 372 memorizes the sample image data (data showing the background image and illustrated image) corresponding to the types of information on sample identification D1, D2 and D3, and memorizes at least one of the data items on the template for setting the composite area with the sample image data. When a predetermined template is selected from among multiple templates previously memorized in the template memory section 372 by the operation by the operator (based on the instruction of a client), the control section 307 performs merging between the frame image information and the selected template. When the types of information on sample identification D1, D2 and D3 have been specified by the operation by the operator (based on the instruction of a client), the sample image data is selected in conformity to the specified types of information on sample identification D1, D2 and D3. Merging of the selected sample image data, image data ordered by a client and/or character data is carried out and, as a result, a print in conformity to the sample image data desired by the client is created. Merging by this template is performed by the widely known chromakey technique.

Sample identification information is not restricted to three types of information on sample identification D1, D2 and D3. More than three types or less than three types can be used. The types of information on sample identification D1, D2 and D3 for specifying the print sample are arranged to be inputted from the operation section 311. Since the types of information on sample identification D1, D2 and D3 are recorded on the sample or order sheet, they can be read by the reading section such as an OCR. Alternatively, they can be inputted by the operator through a keyboard.

As described above, sample image data is recorded in response to sample identification information D1 for specifying the print sample, and the sample identification information D1 for specifying the print sample is inputted. Based on the inputted sample identification information D1, sample image data is selected, and the selected sample image data and image data and/or character data based on the order are merged to create a print according to the specified sample. This procedure allows a user to directly check full-sized samples of various dimensions before placing an order. This permits wide-ranging user requirements to be satisfied.

The first sample identification information D2 for specifying the first sample, and first sample image data are memorized; alternatively, the second sample identification information D3 for specifying the second sample, and second sample image data are memorized. The sample image data selected on the basis of the specified first and second sample identification information D2 and D3, and ordered image data and/or character data are merged with each other, and a print is created according to the specified sample. This procedure allows a greater variety of images to be created, and permits wide-ranging user requirements to be satisfied.

In the exposure processing section 304, the photographic material is exposed and an image is formed thereon in conformity to the output image data generated by image processing of image data by the image processing section 370. This photographic material is sent to the print creating section 305. The print creating section 305 develops ad dries the exposed photographic material to create prints P1, P2 and P3. Print P1 is available in a service size, high-vision size or panorama size. Print P2 is an A4-sized print, print P3 is a business card-sized print (2 in.×3 in.).

Print sizes are not restricted to P1, P2 and P3. Other sized prints can also be used.

The monitor 308 displays the image information inputted from the control section 307.

The image write section 315 is provided with a floppy disk adaptor 315a, MO adaptor 315b, and optical disk adaptor 315c as an image transfer section 331 so that the FD 316a, MO 316b and optical disk 316c can be inserted. This allows the image data to be written on the image-recording medium.

Using the communications means (input) 340 (illustrated in FIG. 15), the image processing apparatus 370 receives image data representing the captured image and printing and other work instruction directly from another computer in the facilities or from a remote computer through Internet, and is cable of performing image processing and printing in the remote control mode.

Using the communications means (input) 340 (illustrated in FIG. 15), the image processing apparatus 370 is capable of sending the image data representing the photographed image after image processing of the present invention has been applied, and accompanying order information, to another computer in the facilities or a remote computer through Internet.

As described in the above, the image recording apparatus 301 is provided with: an input section for capturing the digital image data of various types and image information obtained by dividing the image document and measuring a property of light; an image processing section for processing the information on the input image captured from this input section in such a way that this image will provide a favorable impression when viewed on the outputting medium, by getting or estimating the information on “size of the output image” and “size of the major subject in the output image”; an image outputting section for displaying or printing out and measuring a property of light, or writing it on the image recording medium; and a communications section (output) 341 for sending the image data and accompanying order information to another computer in the facilities through a communications line or a remote computer through Internet.

<Configuration of Image Processing Apparatus 370>

FIG. 15 is a block diagram representing the functional configuration of an image processing apparatus 370 of the present invention. The image data inputted from the film scanner 309 is subjected to calibration inherent to the film scanner, negative/positive reversal of a negative document, removal of dust and scratch, gray balance adjustment, contrast adjustment, removal of granular noise an enhancement of sharpness in the film scan data processing section 702, and is sent to the image adjustment processing section 701. The film size, negative/positive type, information on the major subject recorded optically or magnetically on the film and information on photographing conditions (e.g. information described on the APS) are outputted to the image adjustment processing apparatus 701.

The image data inputted from the reflected document input apparatus 310 is subjected to calibration inherent to a reflected document input apparatus negative/positive reversal of a negative document, removal of dust and scratch, gray balance adjustment, contrast adjustment, removal of granular noise an enhancement of sharpness in the film scan data processing section 702 in the reflected document scanned data processing section 703, and the result is outputted to the image adjustment processing section 701.

The image data inputted from the image transfer section 330 and the communications section (input) 340 is subjected to decompression of the compressed symbols or conversion of the color data representation method, as required, according to the form of the data in the image data form deciphering processing section 704. It is converted into the data format suitable for numerical computation inside the image processing section 370 and is outputted to the image adjustment processing apparatus 701. Further, in the image data form deciphering processing section 704, when the input image data are judged as the reference image data attached with differential image data, the input image data are sent to the reference image data processing section 401. In this process, either the scene-referred image data or the output-referred image data could be acceptable as the input image data. When the scene-referred image data is the input image data, a stereoscopic display image, which is optimized by the image-recording apparatus 301 without any loss of the image information, can be desirably obtained on the display device.

Designation of the size of output image is inputted from the operation section 311. Further, if there is designation of the size of the output image sent to the communications means (input) 340 or the output image embedded in the header/tag information of the image data obtained through the image transfer section 230, the image data form deciphering processing section 704 detects the information and sends it to the image adjustment processing apparatus 701.

The reference image data processing section 401 includes a header information analysis section 402, differential image data reading section 403, differential image data generating section 404, parallax image data generating section 405, reference image data generating section 406 and stereoscopic vision image data generating section 407 for stereoscopic vision display and is connected with an output condition input section 409.

The header information analysis section 402 as identifying means analyzes the header information (tag information in the header area) of the file of the reference image data inputted from the image data form decoding processing section 704, and identifies the attachment identifying information. It then outputs the result of identification to the differential image data reading section 403, parallax image data generating section 405 and reference image data generating section 406.

The differential image data reading section 403 as a separating means reads the differential image data from a predetermined area of the inputted area, based on the result of identifying the attachment identifying information as analyzed by the header information analysis section 402, and separates the reference image data from the differential image data. The differential image data generating section 404 processes the read differential image data so that it can be subjected to image processing.

From the differential image data and reference image data, the parallax image data generating section 405 generates the parallax image data forming a pair with the reference image data in stereoscopic vision display. The parallax image data is generated from the following equation:

where

A1: reference image data

A2: parallax image data

B: differential image data

A2=A1+B

The reference image data generating section 406 reads the reference image data from the inputted file format, and processes it so that it can be subjected to image processing.

Based on the output condition setting inputted from the output condition setting input section 408, the stereoscopic vision image data generating section 407 for stereoscopic vision display generates the image for stereoscopic vision display, from the reference image data and parallax image data. To put it more specifically, stereoscopic vision image data generating section 407 for stereoscopic vision display adjusts the size of each image in such a way that the distance between viewpoints of two images—the reference image and parallax image—will be kept at a distance of at least about 6 through 7 cm, which is equal to the distance between human eyes, as shown in FIG. 9, and generates the image data for stereoscopic vision display in such a way that the images are correctly arranged on the plane according to the observation conditions of the parallel method or cross method. When the inputted reference image data is the scene-referred image data, stereoscopic vision image data generating section 407 for stereoscopic vision display as output-referred image data generating means, based on the information inputted from the output condition setting input section 408, applies the processing of optimization to both the reference image data and parallax image data in such a way that the optimum output-referred image can be obtained on the output medium (CRT, liquid crystal display, plasma display, silver halide photographic paper, ink jet paper, thermal printer paper, etc.). After converting each of the aforementioned data sets to the output-referred image data, the stereoscopic vision image data generating section 407 for stereoscopic vision display adjusts the size of each image in such a way that the distance between viewpoints of two images—the reference image and parallax image—will be kept at a distance of at least about 6 through 7 cm, which is equal to the distance between human eyes, and generates the image data for stereoscopic vision display in such a way that the images are correctly arranged on the plane according to the observation conditions of the parallel method or cross method.

The output condition input section 409 consists of a user interface such as a keyboard and touch panel on the LCD. When the information on the output setting (e.g. device type of the output destination and output size) of the digital image data generated by the image recording apparatus 301 has been inputted, the output condition setting inputting section 409 outputs this information to the image recording apparatus generating section 408 for stereoscopic vision display. The output condition input section 409 can be integrally built with the operation section 311.

The image data for stereoscopic vision display generated by the reference image data processing section 401 is outputted to the image adjustment processing section 701.

The image adjustment processing apparatus 701 calls a predetermined image data (template) from the template memory section 372 when template processing is required. Image data is sent to the template processing section 705. It is merged with the template, and the image data subsequent to template processing is again received. In response to the instruction from the operation section 311 and control section 307, the image adjustment processing apparatus 701 applies image processing to the image data received from the film scanner 309, image transfer section 330, communications means (input) 340, template processing section 705 and reference image data processing section 401, in such a way that the image will provide a favorable impression when viewed on the outputting medium. Then the digital image data to be outputted is generated, and is sent to the CRT inherent processing section 706, printer inherent processing section (1) 707, image data form creation processing section 709 and data storage section 371.

The CRT inherent processing section 706 applies processing of changing the number of pixels or color matching to the image data received from the image adjustment processing apparatus 701, as required. Then the image data for display merged with the information requiring control information, etc. is sent to the CRT 308, serving as an image-forming means. The printer inherent processing section (1) 707 provides processing of printer inherent calibration, color matching and change in the number of pixels, as required, and sends image data to the exposure processing section 304, serving as an image-forming means. When an external printer 351 such as a large-format inkjet printer, serving as an image-forming device, is to be connected to the image recording apparatus 301, a printer inherent processing section (2) 708 is provided for each printer to be connected, so that adequate printer inherent calibration, color matching, change in the number of pixels and other processing can be carried out.

The image data form creation processing section 709 converts the image data received from the image adjustment processing apparatus 701, into various types of general-purpose image format represented by JPEG, TIFF and Exif as required. Then the image data is sent to the image transfer section 331 and communications means (input) 341.

The stereoscopic vision image data created by the reference image data processing section 401 assumes processing by the CRT inherent processing section 706, printer inherent processing section (1) 707, printer inherent processing section (2) 708 and image data form creation processing section 709. The image data form creation processing section 709 attaches to this image data the status file identifying the optimized image data for CRT, exposure output section, external printer, communications means (output) and others, based on the format of the stereoscopic vision image data, and sends the resultant image data separately to the image transfer section.

The above-mentioned division into the film scan data processing section 702, reflected document scanned data processing section 703, image data form deciphering processing section 704, image adjustment processing apparatus 701, CRT inherent processing section 706, printer inherent processing section (1) 707, printer inherent processing section (2) 708 and image data form creation processing section 709 is assumed to assist understanding of the functions of the image processing section 370. They need not necessarily be realized as physically independent devices. For example, they can be realized in the form of a division of the type of software processing in a single CPU.

Further, the division of the header information analysis section 402, differential image data reading section 403, differential image data generating section 404, parallax image data generating section 405, reference image data generating section 406, stereoscopic vision image data generating section 407 is assumed to assist understanding of the functions of the image processing section 370 of the present invention. They need not necessarily be realized as physically independent devices. For example, they can be realized in the form of a division of the type of software processing in a single CPU.

<Operation of Image Processing Section 370>

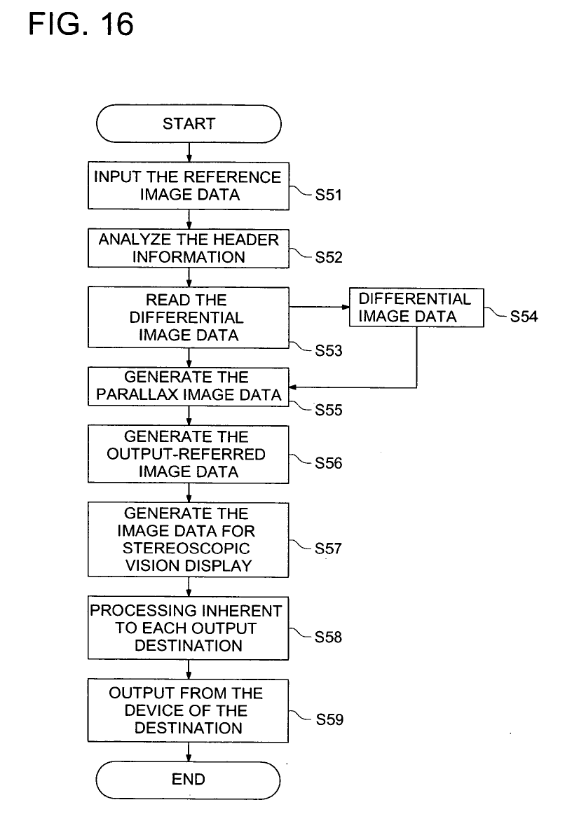

FIG. 16 is a flowchart showing the processing of forming the stereoscopic vision image data, performed by the cooperation of various components of an image recording apparatus 370. Referring to the drawing, the following describes the operations of various parts of the image processing section 370.

Data is inputted from the image transfer section 330 or communications means (input) 340 to the image processing section 370. When the image data form deciphering processing section 704 has identified this inputted data as a reference image data file for stereoscopic vision display (Step S51), the header information of the file format of the reference image data is analyzed by the header information analysis section 402, and the attachment identifying information is identified (Step S52). Based on the result of analysis by the header information analysis section 402, the differential image data is read from a predetermined area of the file by the differential image data reading section 403, and reference image data is separated from and differential image data (Step S53). The data is processed by the differential image data generating section 404, thereby generating the differential image data that can be subjected to image processing.

The parallax image data generating section 405 generates the parallax image data from the reference image data and differential image data (Step S55). Based on the output conditions inputted by the output condition setting input section 408, the stereoscopic vision image data generating section 407 for stereoscopic vision display applies processing of optimization to each of the reference image data and parallax image data so that the optimum output-referred image data can be obtained on the output medium, and the data is converted into the output-referred image data (Step S56). This step can be omitted if the inputted reference image data is output-referred image data.

Based on the output conditions inputted from the output condition setting input section 408, the stereoscopic vision image data generating section 407 for stereoscopic vision display adjusts the size and layout of two images—reference image and parallax image—so as to be best suited to stereoscopic vision display of stereopair, whereby image data for stereoscopic vision display is generated (Step S57). In response to the output destination, the image data for stereoscopic vision display is outputted to the processing section of one of the CRT inherent processing section 706, printer inherent processing section 707, printer inherent processing section 708 and image data form creation processing section 709. Processing inherent to the output destination is applied by the processing section where it has been outputted (Step S58). The output-referred image for stereoscopic vision display is formed on the display device such as a CRT, liquid crystal display and plasma display, and on the output medium including hard copy generation paper such as silver halide photographic paper ink jet paper and thermal printer paper (Step S59).

As described above, the image recording apparatus 301 of the present invention decodes the inputted image data. If the inputted image data is the reference image data for stereoscopic vision display, image data for stereoscopic vision display is generated from the reference image data and differential image data attached to the reference image data. The output-referred image data is formed on the display device such as a CRT, liquid crystal display and plasma display, and on the output medium including hard copy generation paper such as silver halide photographic paper ink jet paper and thermal printer paper. This arrangement ensures effective printing even when the captured-image data photographed for stereoscopic vision display is present together with normal captured-image data not intended for stereoscopic vision display.

The description of the aforementioned embodiment is concerned with only a preferred example of the image-capturing apparatus, image processing apparatus and image recording apparatus of the present invention, without the present invention being restricted thereto. The detailed configuration and operation of each apparatus can be modified adequately, without departing from the spirit of the present invention.

As described in the foregoing, according to the present invention, the following effects can be attained.

(1) At least one reference image data set is selected from a plurality of captured-image data sets acquired by photographing one and the same subject from different viewpoints, and a differential image data set between the selected reference image data and other captured-image data is extracted. The extracted differential image data is attached to the reference image data, and the attachment identifying information for indicating attachment of that differential image data is attached to the reference image data.

Accordingly, a plurality of captured-image data sets acquired by photographing one and the same subject from different viewpoints, i.e. a plurality of captured-image data sets acquired by photographing for the purpose of stereoscopic vision display, can be handled as a single captured-image data set. This arrangement improves the searching efficiency in searching the captured-image data acquired by photographing for the purpose of stereoscopic vision display from a plurality of captured-image data sets, and permits outputting as one photographic print of the reference image data by the printer incompatible with stereoscopic vision display. This improves compatibility between the captured-image data acquired by photographing for the purpose of stereoscopic vision display and the normal captured-image data acquired by photographing one and the same subject from different viewpoints, and upgrades the versatility and convenience of the captured-image data for stereoscopic vision display.

It is preferred that attachment identifying information be recorded on the header area of the captured-image data as tag information. Further, to ensure that the captured-image data can be processed into the optimum image data in conformity to a destination, it is preferred that the data be outputted as scene-referred image data without information loss from the information obtained by photographing.

(2) Upon entry of the differential image data containing the difference between the reference image data out of a plurality of captured-image data sets acquired by photographing one and the same subject from different viewpoints and other captured-image data, the reference image data with this differential image data attached thereto, and the attachment identifying information for indicating attachment of the differential image data to the reference image data, the reference image data is separated from the differential image data based on the attachment identifying information. Based on the separated reference image data and differential image data, the parallax image data is generated, and based on the reference image data and parallax image data, image data for stereoscopic vision display is generated. Further, the image recording apparatus allows the image data for stereoscopic vision display to be formed on an output medium.

Accordingly, automatic identification is performed to confirm that the inputted captured-image data is the reference image data, acquired by photographing for the purpose of stereoscopic vision display, with the differential image data attached thereto, i.e. the data of the format generated by the image processing method, image-capturing apparatus and image processing apparatus embodied in the present invention. This arrangement makes it possible to generate image data for stereoscopic vision display from the reference image data and differential image data, and enables effective generation of image data for stereoscopic vision display.

(3) It is preferred that the attachment identifying information be recorded on the header area of captured-image data as tag information. It is also preferred that the inputted data be scene-referred image data without information loss from the information obtained by photographing. The optimization processing for forming the optimum image on the output medium is applied to the reference image data of the scene-referred image data and the parallax image data, and the data is converted into the scene-referred image data, whereby the optimum image of the still higher degree can be obtained on the output medium.

Disclosed embodiment can be varied by a skilled person without departing from the spirit and scope of the invention.

What is claimed is:

1. An image-processing method for outputting one of a plurality of captured image data sets, each of which represents each of a plurality of images acquired by photographing a same subject from plural viewpoints being different relative to each other, said image-processing method comprising the steps of:
selecting a reference image data set out of said plurality of captured image data sets;
extracting differential image data between said reference image data set selected in said selecting step and other captured image data sets, both included in said plurality of captured image data sets; and
attaching said differential image data, extracted in said extracting step, and attachment-identifying information of said differential image data to said reference image data set.

2. The image-processing method of claim 1,
wherein said attachment-identifying information are recorded into a header area of said reference image data set as tag information in said attaching step.

3. The image-processing method of claim 1,
wherein said captured image data sets are scene-referred image data sets.

4. An image-processing method for generating output image data by applying an optimization processing, for optimizing an output image to be formed on an outputting medium, to captured image data, said image-processing method comprising the steps of:
inputting a reference image data set to which differential image data and attachment-identifying information of said differential image data are attached;
separating said differential image data from said reference image data set, based on said attachment-identifying information;
generating parallax image data, based on both said reference image data set and said differential image data, both separated in said separating step; and
generating stereoscopic-vision image data for forming a stereoscopic vision on said outputting medium, based on said reference image data set and said parallax image data;
wherein said reference image data set is selected out of a plurality of captured image data sets, each of which represents each of a plurality of images acquired by photographing a same subject from plural viewpoints being different relative to each other, and said differential image data represent differential components between said reference image data set and other captured image data sets, both included in said plurality of captured image data sets.

5. The image-processing method of claim 4,
wherein said attachment-identifying information are tag information recorded into a header area of said reference image data set.

6. The image-processing method of claim 4,
wherein said captured image data sets are scene-referred image data sets; and further comprising the steps of:
applying said optimization processing, for optimizing said output image to be formed on said outputting medium, to said reference image data set and said parallax image data, so that said scene-referred image data sets are converted to output-referred image data.

7. An image-capturing apparatus for generating a plurality of captured image data sets, each of which represents each of a plurality of images acquired by photographing a same subject from plural viewpoints being different relative to each other, said image-capturing apparatus comprising:
a reference image data selecting section to select a reference image data set out of said plurality of captured image data sets;
a differential image data extracting section to extract differential image data between said reference image data set selected by said reference image data selecting section and other captured image data sets, both included in said plurality of captured image data sets; and
a data attaching section to attach said differential image data, extracted by said differential image data extracting section, and attachment-identifying information of said differential image data to said reference image data set.

8. The image-capturing apparatus of claim 7,
wherein said data attaching section records said attachment-identifying information into a header area of said reference image data set as tag information.

9. The image-capturing apparatus of claim 7,
wherein said captured image data sets are scene-referred image data sets.

10. An image-processing apparatus for outputting one of a plurality of captured image data sets, each of which represents each of a plurality of images acquired by photographing a same subject from plural viewpoints being different relative to each other, said image-processing apparatus comprising:
a reference image data selecting section to select a reference image data set out of said plurality of captured image data sets;
a differential image data extracting section to extract differential image data between said reference image data set selected by said reference image data selecting section and other captured image data sets, both included in said plurality of captured image data sets; and
a data attaching section to attach said differential image data, extracted by said differential image data extracting section, and attachment-identifying information of said differential image data to said reference image data set.

11. The image-processing apparatus of claim 10,
wherein said data attaching section records said attachment-identifying information into a header area of said reference image data set as tag information.

12. The image-processing apparatus of claim 10,
wherein said captured image data sets are scene-referred image data sets.

13. An image-processing apparatus for generating output image data by applying an optimization processing, for optimizing an output image to be formed on an outputting medium, to captured image data, said image-processing apparatus comprising:
an inputting section to input a reference image data set to which differential image data and attachment-identifying information of said differential image data are attached;
an identifying section to identify said attachment-identifying information so as to output an identified result;
a data separating section to separate said differential image data from said reference image data set, based on said identified result outputted by said data separating section;
a parallax image data generating section to generate parallax image data, based on both said reference image data set and said differential image data, both separated by said data separating section; and
a stereoscopic-vision image data generating section to generate stereoscopic-vision image data for forming a stereoscopic vision on said outputting medium, based on said reference image data set and said parallax image data;
wherein said reference image data set is selected out of a plurality of captured image data sets, each of which represents each of a plurality of images acquired by photographing a same subject from plural viewpoints being different relative to each other, and said differential image data represent differential components between said reference image data set and other captured image data sets, both included in said plurality of captured image data sets.

14. The image-processing apparatus of claim 13,
wherein said attachment-identifying information are tag information recorded into a header area of said reference image data set.

15. The image-processing apparatus of claim 13,
wherein said captured image data sets are scene-referred image data sets; and said image-processing apparatus further comprising:
an output-referred image data generating section to convert said scene-referred image data sets to output-referred image data by applying said optimization processing, for optimizing said output image to be formed on said outputting medium, to said reference image data set and said parallax image data;
wherein said stereoscopic-vision image data generating section generates said stereoscopic-vision image data, based on said output-referred image data.

16. An image-recording apparatus that forms an output image on an outputting medium, based on output image data generated by applying an optimization processing to captured image data, said image-recording apparatus comprising:
an inputting section to input a reference image data set to which differential image data and attachment-identifying information of said differential image data are attached;
an identifying section to identify said attachment-identifying information so as to output an identified result;
a data separating section to separate said differential image data from said reference image data set, based on said identified result outputted by said data separating section;
a parallax image data generating section to generate parallax image data, based on both said reference image data set and said differential image data, both separated by said data separating section;
a stereoscopic-vision image data generating section to generate stereoscopic-vision image data for forming a stereoscopic vision on said outputting medium, based on said reference image data set and said parallax image data; and
an image-forming section to form a stereoscopic-vision image onto said outputting medium, based on said stereoscopic-vision image data generated by said stereoscopic-vision image data generating section;
wherein said reference image data set is selected out of a plurality of captured image data sets, each of which represents each of a plurality of images acquired by photographing a same subject from plural viewpoints being different relative to each other, and said differential image data represent differential components between said reference image data set and other captured image data sets, both included in said plurality of captured image data sets.

17. The image-recording apparatus of claim 16,
wherein said attachment-identifying information are tag information recorded into a header area of said reference image data set.

18. The image-recording apparatus of claim 17,
wherein said captured image data sets are scene-referred image data sets; and further comprising:
an output-referred image data generating section to convert said scene-referred image data sets to output-referred image data by applying said optimization processing, for optimizing said output image to be formed on said outputting medium, to said reference image data set and said parallax image data; and
wherein said stereoscopic-vision image data generating section generates said stereoscopic-vision image data, based on said output-referred image data.
